(19) United States
(12) Patent Application Publication
(10) Pub. No.: US 2025/0183272 A1
(43) Pub. Date: Jun. 5, 2025

(54) GRAPHENE AND SILICON BASED ANODES FOR LITHIUM-ION BATTERIES

(71) Applicant: Universal Matter Inc., Burlington (CA)

(72) Inventor: Vladimir Mancevski, Austin, TX (US)

(21) Appl. No.: 18/841,553

(22) PCT Filed: Feb. 27, 2023
(86) PCT No.: PCT/CA2023/050249

§ 371 Date: Aug. 26, 2024

Related U.S. Application Data
(60) Provisional application No. 63/314,103, filed on Feb. 25, 2022.

(51) Int. Cl. H01M 4/36; H01M 4/02; H01M 4/38; H01M 4/48; H01M 4/587; H01M 10/0525; H01M 10/054

(52) U.S. Cl. CPC H01M 4/366; H01M 4/386; H01M 4/48; H01M 4/587; H01M 10/0525; H01M 10/054; H01M 2004/021

(57) ABSTRACT

Described herein are composite materials and manufacturing methods of the composite materials, the materials comprising graphene and silicon, wherein the materials may be applied to energy storage devices, including anodes for Li-ion batteries. In some embodiments, the materials may comprise turbostratic graphene, wherein the turbostratic graphene has graphene layers that are misoriented with respect to each other.

### TECHNICAL FIELD

The following relates to composites comprising graphene and silicon-based materials that may be applied to energy storage devices, including anodes for Li-ion batteries and processes for manufacturing of such composites.

### INTRODUCTION

U.S. Pat. No. 11,174,167 to Dhanabalan et. al., published Nov. 11, 2021, describes “Silicon carbon composites comprising ultra low Z.” In this disclosure anode material is made from nano porous carbon scaffold where Si is vapor deposited within the pores of the carbon scaffold. The disadvantage of a porous carbon scaffold is that it lacks the strength and the electrical conductivity of graphene nanoparticles and that of a graphene material.

U.S. Pat. No. 11,101,458 to Yushin et. al., published Oct. 3, 2019, describes “Scaffolding matrix with internal nanoparticles.” In this disclosure anode material is prepared by forming porous, electrically conductive scaffolding matrix within which active material is inserted, via deposited, solution infiltration, vapor infiltration, atomic layer deposition, electroplating. In another disclosed method active-nanoparticles are adsorbed into a polymeric precursor for carbon formation, wherein thermal treatment carbonizes the polymer precursor and forms nanocomposite shell comprising active nanoparticles, carbon and nanopores. The disadvantage of a porous carbon scaffold is that it lacks the strength and the electrical conductivity of a graphene material. The disadvantage of the porous carbon scaffold with embedded active material (like Si) is that it lacks the strength and the electrical conductivity of a graphene material.

U.S. Pat. No. 8,673,502 to Petrat et. al., published Mar. 18, 2014, describes “Method for producing coated carbon particles and use of the latter in anode materials for lithium-ion batteries.” In this disclosure they claim anode material that is made by vapor deposition of Si onto graphite particles and carbon black. The primary particles preferably have a mean particle diameter of from 20 to 60 nm. The disadvantage of a Si coated carbon black is that it lacks the strength and the electrical conductivity of a graphene nanoparticle.

Li, Y. et al., Growth of conformal graphene cages on micrometre-sized silicon particles as stable battery anodes, Nat Energy 1, 15029 (2016) discloses graphene encapsulated silicon microparticles. The disadvantage of this structure is that it requires an expensive to implement Ni catalyst layer to be deposited on the Si microparticle, followed by lengthy (˜8 h) carburization process, before graphene is formed using expensive oven deposition system that requires constant flow of inert gas to flow during the deposition. In addition, the graphene of this disclosure is AB stacked instead of turbostratic. In addition, the level of graphitization as evident (from the Raman 2D peak and the TEM images) from FIG. 2 of this disclosure is very low, suggesting low crystallization graphene.

Sang Cheol Kim et al., Graphene coating on silicon anodes enabled by thermal surface modification for high-energy lithium-ion batteries, MRS BULLETIN. VOLUME 47, February 2022 discloses graphene coated micro silicon particles. The disadvantage of this structure is that it requires an expensive chemical vapor deposition process that requires vacuum chambers and constant flow of process gases to flow during the deposition. In addition, the graphene of this disclosure is AB stacked. In addition, the level of graphitization as evident (from the Raman 2D peak and the TEM images) from FIGS. 1 and 4 of this disclosure is very low.

Son, I et al., Silicon carbide-free graphene growth on silicon for lithium-ion battery with high volumetric energy density, Nat Commun 6, 7393 (2015) discloses graphene growth over nano silicon particles. The disadvantage of this structure is that it requires an expensive chemical vapor deposition process and methane process gas. In addition, the graphene of this disclosure is AB stacked. In addition, the level of graphitization as evident (from the TEM images and XRD analysis) from FIGS. 1 and S1 and S2 of this disclosure is very low.

General approaches of making Si based anodes by mixing graphene sheets with Si nanoparticles (including having the graphene sheets wrinkled in ball format) lack the electrical connectivity between the graphene and the Si nanoparticles. Another disadvantage of these approaches is the loose mobility of the Si inside the graphene sheet that will not prevent the Si pulverization during lithiation/delithiation processes. Another disadvantage of this approach is the low mass Si loading relative to the graphene mass.

### SUMMARY

Described herein are composite materials and manufacturing methods of the composite materials, the materials comprising graphene and silicon, wherein the materials may be applied to energy storage devices, including anodes for Li-ion batteries. In some embodiments, the materials may comprise turbostratic graphene, wherein the graphene has little order between the graphene layers.

Disclosed herein, is a composite material according to an embodiment, the material comprising a graphene nanoparticle, the graphene nanoparticle at least partially coated with silicon.

According to some embodiments, the graphene nanoparticle is a turbostratic graphene nanoparticle.

According to some embodiments, the graphene nanoparticle is a polyhedral graphene nanoparticle.

According to some embodiments, the graphene nanoparticle is a spherical graphene nanoparticle.

According to some embodiments, the graphene nanoparticle is porous.

According to some embodiments, the pores of the graphene nanoparticle are at least partially filled with silicon.

According to some embodiments, the graphene nanoparticle comprises a hollow core.

According to some embodiments, the hollow core is at least partially filled with silicon.

According to some embodiments, the silicon coating is coated with carbon.

According to some embodiments, the silicon coating is coated with graphene.

According to some embodiments, the carbon coating is electrically conductive.

According to some embodiments, the silicon coating comprises a first layer of silicon, and a second later of silicon of differing compositions.

According to some embodiments, the second layer is further coated with graphene.

According to some embodiments, the silicon coating comprises elemental silicon.

According to some embodiments, the silicon coating comprises SiO, SiOx, or SiO2.

According to some embodiments, the silicon coating comprises silicon carbide.

According to some embodiments, the material comprises a branched structure.

According to some embodiments, wherein the graphene nanoparticle is doped with nitrogen.

According to some embodiments, the material is applied as a battery anode.

According to some embodiments, the battery is a lithium ion battery.

According to some embodiments, the battery is a sodium ion battery.

Described herein is a composite material, according to an embodiment, the material including a silicon nanoparticle, the silicon nanoparticle at least partially coated with turbostratic graphene.

According to some embodiments, the graphene coating is porous.

According to some embodiments, the graphene coating comprises polyhedral graphene.

According to some embodiments, the silicon nanoparticle comprises Si, SiO, SiOx, SiO2 or SiC.

According to some embodiments, the silicon nanoparticle comprises a first silicon layer and a second silicon layer of differing compositions.

According to some embodiments, the composite material comprises a void between the silicon nanoparticle and graphene coating.

According to some embodiments, the silicon nanoparticle comprises elemental silicon.

According to some embodiments, the silicon nanoparticle has a diameter between 5 nm and 50 microns.

According to some embodiments, the material is applied as a battery anode. According to some embodiments, the battery is a lithium ion battery.

According to some embodiments, the battery is a sodium ion battery.

Described herein is a material according to an embodiment, the material including empty shell turbostratic graphene particles.

According to some embodiments, the graphene particles are porous.

According to some embodiments, the graphene shell is filled with Li, Na, Sn, CO2, or H2.

According to some embodiments, the material is applied as a chemical battery anode.

According to some embodiments, the battery is a lithium ion battery.

According to some embodiments, the battery is a sodium ion battery.

Described herein is a method of producing a composite material according to an embodiment, the method including providing a turbostratic graphene nanoparticle and coating the graphene nanoparticle with a silicon material.

According to some embodiments, the nanoparticle is coated by chemical vapor deposition.

According to some embodiments, the graphene nanoparticle is a polyhedral graphene nanoparticle.

According to some embodiments, the graphene nanoparticle is a spherical graphene nanoparticle.

According to some embodiments, the graphene nanoparticle is porous.

According to some embodiments, the pores are filled with silicon.

According to some embodiments, the graphene nanoparticle comprises a hollow core.

According to some embodiments, the hollow core is at least partially filled with silicon.

According to some embodiments, the method further includes coating the silicon coating with carbon.

According to some embodiments, the carbon coating is electrically conductive.

According to some embodiments, the silicon coating comprises a first silicon layer and a second silicon layer of differing compositions.

According to some embodiments, the silicon coating comprises elemental silicon.

According to some embodiments, the silicon coating comprises SiO, SiOx, or SiO2.

According to some embodiments, the silicon coating comprises silicon carbide.

According to some embodiments, the method further includes forming the material into a branched structure.

According to some embodiments, the graphene nanoparticle is doped with nitrogen.

Described herein is a method of producing a composite material, according to an embodiment, the method including providing a silicon nanoparticle, coating the silicon nanoparticle with a carbon material and joule heating the coated silicon nanoparticle to convert the carbon coating to graphene.

According to some embodiments, coating the silicon nanoparticle with a carbon material comprises direct carbon coating through thermal gas decomposition.

According to some embodiments, the direct carbon coating comprises nitrogen doped carbon.

According to some embodiments, the direct carbon coating comprises urea, melamine, glucosamine, cyanamide, amino acids, proteins, or chitin.

According to some embodiments, coating the silicon nanoparticle with a carbon material comprises direct carbon coating through hydrothermal carbonization of carbohydrates.

According to some embodiments, the carbohydrates comprise glucose, fructose, sucrose, or combinations thereof.

According to some embodiments, the carbon material comprises carbon black.

According to some embodiments, the silicon nanoparticle comprises elemental silicon.

According to some embodiments, the silicon nanoparticle comprises SiO, SiOx, or SiO2.

According to some embodiments, the silicon nanoparticle and carbon coating comprise a mass ratio between 90:10 and 10:90.

According to some embodiments, the graphene coating is porous.

According to some embodiments, the graphene comprises polyhedral graphene.

According to some embodiments, the composite material comprises a void between the silicon nanoparticle and graphene coating.

According to some embodiments, the silicon nanoparticle has a diameter between 5 nm and 50 microns.

Described herein is a method of producing a composite material, the method including providing a silicon nanoparticle, coating the nanoparticle with an amorphous carbon material, heating the coated nanoparticle to pyrolyze the amorphous carbon material and joule heating the nanoparticle to convert the pyrolyzed carbon material into turbostratic graphene.

According to some embodiments, the method further includes coating the silicon nanoparticle with a sacrificial layer before coating the nanoparticle with the amorphous carbon material, and etching the sacrificial layer after the Joule heating process to produce a void between the silicon nanoparticle and turbostratic graphene.

According to some embodiments, the method further includes etching the silicon nanoparticle to produce a void between the silicon nanoparticle and pyrolyzed carbon.

According to some embodiments, the method further includes etching the silicon nanoparticle before the joule heating process to produce a void between the silicon nanoparticle and turbostratic graphene.

According to some embodiments, the method further includes etching the silicon nanoparticle before the joule heating process to produce a void between the silicon nanoparticle and pyrolyzed carbon.

According to some embodiments of the methods and materials described herein, turbostratic graphene comprises graphene layers which are misoriented with respect to each other.

Aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a cross-sectional schematic of a hollow polyhedral graphene nanoparticle before coating, according to an embodiment;

FIG. 1B is a cross-sectional schematic the hollow polyhedral graphene nanoparticle of FIG. 1A after coating with Si, according to an embodiment;

FIG. 1C is a cross-sectional schematic of a solid polyhedral graphene nanoparticle after coating with Si, according to an embodiment;

FIG. 2A is a cross-sectional schematic of a hollow polyhedral graphene nanoparticle before coating, according to an embodiment;

FIG. 2B is a cross-sectional schematic of the hollow polyhedral graphene nanoparticle of FIG. 2A after coating with Si, according to an embodiment;

FIG. 2C is a cross-sectional schematic of a solid polyhedral graphene nanoparticle after coating with Si, according to an embodiment;

FIG. 3A is a cross-sectional schematic of a hollow polyhedral graphene nanoparticle before filling, according to an embodiment;

FIG. 3B is a cross-sectional schematic of the hollow polyhedral graphene nanoparticle of FIG. 3A after filling and coating with Si, according to an embodiment;

FIG. 4A is a cross-sectional schematic of a porous hollow polyhedral graphene nanoparticle before coating, according to an embodiment;

FIG. 4B is a cross-sectional schematic of the porous hollow polyhedral graphene nanoparticle of FIG. 4A after coating with Si, according to an embodiment;

FIG. 4C is a cross-sectional schematic of a solid porous polyhedral graphene nanoparticle after coating with Si, according to an embodiment;

FIG. 5A is a cross-sectional schematic of a polyhedral graphene branched structure before coating, according to an embodiment;

FIG. 5B is a cross-sectional schematic of the polyhedral graphene branched structure of FIG. 5A after coating with Si, according to an embodiment;

FIG. 6A is a cross-sectional schematic of a matrix of polyhedral graphene branched structures before coating, according to an embodiment;

FIG. 6B is a cross-sectional schematic of the matrix of polyhedral graphene branched structures of FIG. 6B after coating with Si, according to an embodiment;

FIG. 7A is a cross-sectional schematic of a polyhedral graphene nanoparticle coated with inner Si layer and outer SiOₓ (x<2), SiO₂ layer, according to an embodiment;

FIG. 7B is a cross-sectional schematic of a polyhedral graphene nanoparticle coated with inner Si layer, middle SiOₓ (x<2), SiO₂ layer, and outer carbon layer, according to an embodiment;

FIG. 7C is a cross-sectional schematic of a polyhedral graphene nanoparticle coated with inner Si, SiOₓ (x<2), SiO₂ layer and outer carbon layer, according to an embodiment;

FIG. 8A is a cross-sectional schematic of a Si, SiOₓ (x<2), SiO₂ nanoparticle before coating, according to an embodiment;

FIG. 8B is a cross-sectional schematic of the Si, SiOₓ (x<2), SiO₂ nanoparticle of FIG. 8A covered with carbon black nanoparticles, according to an embodiment;

FIG. 8C is a cross-sectional schematic of the Si, SiOₓ (x<2), SiO₂ nanoparticle of FIG. 8A coated with polyhedral graphene nanoparticles, according to an embodiment;

FIG. 8D is a cross-sectional schematic of a Si nanoparticle core with SiOₓ (x<2), SiO₂ shell coated with polyhedral graphene nanoparticles, according to an embodiment;

FIG. 9A is a SEM image of a Si, SiOₓ (x<2), SiO₂ nanoparticle coated with polyhedral graphene nanoparticles, according to an embodiment;

FIG. 9B is a SEM image of a cluster of Si, SiOₓ (x<2), SiO₂ nanoparticles coated with polyhedral graphene nanoparticles, according to an embodiment;

FIG. 10A is an image of an EDX analysis of the sample of FIG. 9A, according to an embodiment;

FIG. 10B is a cross-sectional schematic of an EDX analysis of the sample of FIG. 9B, according to an embodiment;

FIG. 11A is a cross-sectional schematic of a Si, SiOₓ (x<2), SiO₂ nanoparticle, according to an embodiment;

FIG. 11B is a cross-sectional schematic of the Si, SiOₓ (x<2), SiO₂ nanoparticle of FIG. 11A coated with carbon, according to an embodiment;

FIG. 11C is a cross-sectional schematic of Si, SiOₓ (x<2), SiO₂ nanoparticle of FIG. 11A coated with pyrolyzed carbon, according to an embodiment;

FIG. 11D is a cross-sectional schematic of the Si, SiOₓ (x<2), SiO₂ nanoparticle of FIG. 11A coated with turbostratic graphene, according to an embodiment;

FIG. 11E is a TEM image of multiple Si nanoparticles, with average diameter of 100 nm, covered in graphene, according to an embodiment;

FIG. 11F is a TEM image at 44 kX magnification of an individual Si nanoparticle, covered in graphene, according to an embodiment;

FIG. 11G is a TEM image at 270 kX magnification of an individual Si nanoparticle, covered in graphene, according to an embodiment;

FIG. 11H is a Raman signature of pure Si nanoparticles powder, according to an embodiment;

FIG. 11I is a Raman signature of Si covered with graphene nanoparticles powder, according to an embodiment;

FIG. 11J is a magnified view of the Raman signature of FIG. 11I, according to an embodiment

FIGS. 11K, 11L, 11M and 11N are SEM images and EDX measurements of examples of Si-graphene composite structures, according to an embodiment.

FIG. 11O is a TGA analysis plot of a Si-graphene composite powder, according to an embodiment;

FIG. 12A is a cross-sectional schematic of a Si, SiOₓ (x<2), SiO₂ nanoparticle coated with sacrificial layer and carbon coating, according to an embodiment;

FIG. 12B is a cross-sectional schematic of a Si, SiOₓ (x<2), SiO₂ nanoparticle coated with sacrificial layer and with pyrolyzed carbon, according to an embodiment;

FIG. 12C is a cross-sectional schematic of a Si, SiOₓ (x<2), SiO₂ nanoparticle coated with sacrificial layer and with turbostratic graphene, according to an embodiment;

FIG. 12D is a cross-sectional schematic of a Si, SiOₓ (x<2), SiO₂ nanoparticle coated with turbostratic graphene, and having a void between the graphene and the nanoparticle(s), according to an embodiment;

FIG. 12E is a cross-sectional schematic of a Si, SiOₓ (x<2), SiO₂ nanoparticle coated with pyrolyzed carbon coating, according to an embodiment;

FIG. 12F is the cross-sectional schematic of a Si, SiOₓ (x<2), SiO₂ nanoparticle coated with pyrolyzed carbon coating of FIG. 12E, having a void between the carbon and the nanoparticle(s), according to an embodiment;

FIG. 12G is a cross-sectional schematic of a Si, SiOₓ (x<2), SiO₂ nanoparticle coated with graphene, and having a void between the graphene and the nanoparticle(s), according to an embodiment.

FIG. 12H is an SEM image of an example graphene shells, made from 1 μm average diameter Si sacrificial cores, according to an embodiment;

FIG. 12I is an SEM image and corresponding EDX map of an example TG-shell, according to an embodiment;

FIG. 12J shows an SEM image and corresponding EDX trace of an example TG-shell, according to a further embodiment

FIG. 12K is a cross-sectional schematic of a Si, SiOₓ (x<2), SiO₂ nanoparticle coated with porous carbon coating, according to an embodiment;

FIG. 12L is a cross-sectional schematic of a Si, SiOₓ (x<2), SiO₂ nanoparticle coated with porous graphene, according to an embodiment;

FIG. 13A is a cross-sectional schematic of a Si, SiOₓ (x<2), SiO₂ nanoparticle covered with carbon particles, according to an embodiment;

FIG. 13B is a cross-sectional schematic of a Si, SiOₓ (x<2), SiO₂ nanoparticle coated with turbostratic graphene, according to an embodiment;

FIG. 14A is a cross-sectional schematic of a Si, SiOₓ (x<2), SiO₂ nanoparticle covered with carbon particles and carbon black nanoparticles, according to an embodiment;

FIG. 14B is a cross-sectional schematic of a Si, SiOₓ (x<2), SiO₂ nanoparticle coated with turbostratic graphene and polyhedral graphene nanoparticles, according to an embodiment;

FIG. 15A is a TEM Image of predominately hollow polyhedral graphene nanoparticles, according to an embodiment;

FIG. 15B is a high-resolution TEM image of a polyhedral graphene cluster, according to an embodiment;

FIG. 15C is a very high-resolution TEM image of polyhedral graphene, according to an embodiment;

FIG. 15D is a TEM image of predominately solid polyhedral graphene nanoparticles, according to an embodiment;

FIG. 16A is a high-resolution TEM image of flake-like graphene, according to an embodiment;

FIG. 16B is a very high-resolution TEM image of flake-like graphene, according to an embodiment.

FIG. 17A cross-sectional schematic of a typical lithium-ion battery cell that can utilize the Si-graphene composites of this invention;

FIG. 17B cross-sectional schematic of a lithium-ion battery in discharge operations, according to an embodiment;

FIG. 17C in an image of parts of a Li-Ion battery, according to an embodiment;

FIG. 18A is a cycle-life and specific capacity plot of a Si-graphene composite, a Si-pyrolyzed-carbon composite, and pure Si material, according to an embodiment;

FIG. 19 is a flow chart describing a method of producing a silicon graphene composite material, according to an embodiment;

FIG. 20 is a flow chart describing a method of producing a silicon graphene composite material, according to another embodiment; and

FIG. 21 is a flow chart describing a method of producing a silicon graphene composite material, according to another embodiment.

### DETAILED DESCRIPTION

Various materials, apparatuses or processes will be described below to provide an example of each claimed embodiment. No embodiment described below limits any claimed embodiment and any claimed embodiment may cover materials, processes or apparatuses that differ from those described below. The claimed embodiments are not limited to materials, apparatuses or processes having all of the features of any one apparatus or process described below or to features common to multiple or all of the materials or apparatuses described below.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to graphene and silicon-based materials, and more particularly to graphene and silicon based materials for use in or as anodes for lithium-ion batteries.

A method for producing graphene with flash joule heating has been disclosed in a Nature publication (Luong, D. X., Bets, K. V., Algozeeb, W. A., Stanford, M. G., Kittrell, C., Chen, W., Salvatierra, R. V., Ren, M., McHugh, E. A., Advincula, P. A. and Wang, Z., 2020). Additional details of making graphene with joule heating has been disclosed in International Application No. CA2022051406US filed on Sep. 21, 2022, claiming priority to U.S. Patent App. No. 63/246,424, filed on Sep. 21, 2021, which are hereby incorporated by reference. The disclosures describe the flash joule heating process as one of the tools in making the graphene-silicon composites.

The term “graphene” refers to a material composed of crystalline layered sp2-bonded carbon atoms. In an embodiment, graphene material includes a one-atom-thick planar sheet. In an embodiment, graphene material includes more than one layers of one-atom-thick planar sheets. The graphene material may include a sheet that is densely packed in a honeycomb crystal lattice, and, further, contains an intact ring structure of carbon atoms and aromatic bonds throughout at least a majority of the interior sheet. The graphene material may lack significant oxidation modification of the carbon atoms. Graphene is distinguishable from graphene oxide in that it has a lower degree of oxygen containing groups such as OH, COOH and epoxide.

In an embodiment, graphene includes a nested structure of individual graphene shells with the number of shells ranging from 2 to several 100 s. The nested graphene shells may have a hollow core or may be solid. The nested graphene shells may have a shape of 3D polyhedral structure (like a soccer ball) or may have predominately spherical shape. In some embodiments graphene has predominately spherical shape with diameters from 100 s nanometers to 10 s of microns.

The term “a graphene monolayer” refers to graphene that is a single layer of graphene. The term “a very few layer graphene” refers to a graphene that is between 1 to 3 layers of graphene. The term “a few layer graphene” refers to a graphene that is between 2 to 5 layers of graphene. The term “a multilayer graphene” refers to a graphene that is between 2 to 10 layers of graphene.

The term “turbostratic graphene” (TG) refers to a graphene that has little order between the graphene layers. In an embodiment, turbostratic graphene has random order between graphene layers. In an embodiment, turbostratic graphene has graphene sheets that are twisted randomly with respect to each other. The turbostratic graphene has graphene layers which are misoriented with respect to each other. The graphene layers of TG are not A-B stacked (A-B stacked is also called Bernal-stacked). Instead in turbostratic graphene the adjacent graphene layers are misoriented with respect to each other. Other terms which may be used to describe the order between graphene layers include misoriented, twisted, rotated, rotationally faulted, and weakly coupled.

The rotational stacking of turbostratic graphene helps mitigate interlayer coupling and increases interplanar spacing, thereby yielding superior physical properties relative to competitive graphene structures when compared on a similar weight basis. The subtle difference in adjacent layer stacking orientation expresses itself with important differences in product performance attributes. An important performance benefit evident with turbostratic graphene is that multi-layer graphene structures separate into few and individual graphene layers more easily and the graphene layers tend not to recouple. The turbostratic nature of a graphene may be observed and confirmed by Raman spectroscopy, scanning electron microscopy (SEM), transmission electron microscopy (TEM), selected area electron diffraction (SAED), scanning transmission electron microscopy (STEM), energy dispersive X-ray spectroscopy (EDX), atomic force microscopy (AFM), and X-ray diffraction (XRD) analysis.

The TG that is predominately produced as a result of the joule heating process has two predominate morphologies, a flake-like turbostratic graphene structure (FTG) and polyhedral-like turbostratic graphene structure (PG).

Polyhedral graphene is a closed form of graphene that forms a polyhedral cage, wherein multiple cages are nested within each other. Spherical cage is also possible. In some cases, the polyhedral graphene nanoparticles can have a void (they are hollow). In some cases, they are solid (there is no void). Typical PG graphene ranges from 20 nm to 200 nm in (diameter) size and has from 2 to more than 100 s of layers wall thickness. Polyhedral graphene nanoparticles can self-organize in a branched structure made from multiple PG nanoparticles, ranging in length from few nm to few microns.

The term “carbon source” generally refers to any carbon-based material which may be converted into a graphene material, preferably turbostratic graphene. The carbon source may be in any form including in a powder form or carbon coating. The carbon source may include, without limitation, petroleum coke, tire carbon black, carbon black, metallurgical coke, plastic ash, plastic powder, ground coffee, anthracite coal, coal, corn starch, pine bark, polyethylene microwax, wax, cellulose, naptenic oil, asphaltenes, and gilsonite.

The term “silicon nanoparticle” refers to a nanoparticle predominately made from silicon, silicon monoxide, silicon dioxide, or any combination thereof. SiOx-based materials, SiC, and Si—O—C-based materials are also included. The SiC material may be beta-SiC which is known to have lithium storing capabilities and is used for battery applications. The silicon-based nanoparticle may be amorphous, crystalline or their combination thereof. The silicon-based nanoparticle may be spherical or have an irregular shape. The silicon-based nanoparticle may be in the shape of a rod or nanowire or 2D structure. The silicon-based nanoparticle may be nanoporous, mesoporous, or microporous. Typical silicon-based nanoparticle used with silicon-based anodes for Li-ion batteries may have diameter from 5 nm to few microns.

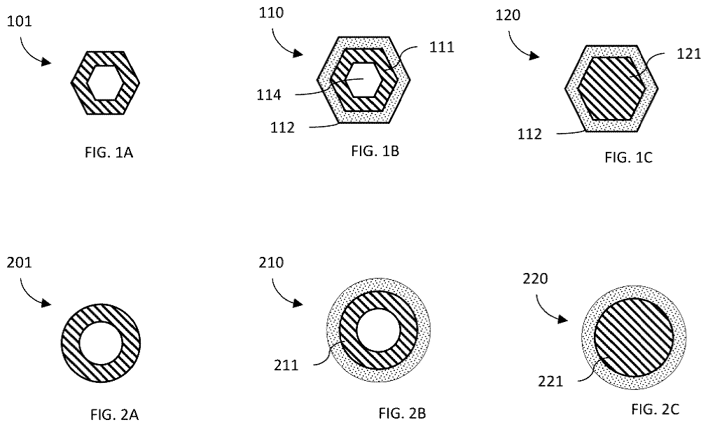

Referring to FIG. 1A, shown there is a cross-sectional schematic of a polyhedral graphene (PG) nanoparticle 101 according to an embodiment. The polyhedral graphene nanoparticle 101 is configured such that a cross section of the polyhedral graphene nanoparticle is polyhedral in shape. The polyhedral graphene nanoparticle is composed of graphene, and in particular, turbostratic graphene.

The polyhedral graphene (PG) nanoparticle 101 may be obtained by joule heating process that converts carbon black nanoparticles into polyhedral turbostratic graphene nanoparticles 101. The polyhedral graphene may be hollow 101 or solid nanoparticle (121) after the flash joule heating, depending on the initial CB feedstock morphology and material composition.

Referring to FIG. 1B, shown therein is a cross-sectional schematic of a hollow PG-Si-based composite 110, according to an embodiment. The hollow PG-Si composite 110 includes a hollow polyhedral graphene nanoparticle 111. The hollow polyhedral graphene nanoparticles 111 may be the polyhedral graphene nanoparticle 101 of FIG. 1A.

The hollow polyhedral graphene nanoparticle 111 includes a void 114 (is hollow). The void 114 is smaller in size than the hollow polyhedral graphene nanoparticle 111 such that the void is internal to the hollow polyhedral graphene nanoparticle 111. The hollow polyhedral graphene nanoparticle 111 is at least partially coated with a silicon deposition 112 to form the hollow PG-Si-based composite 110. The hollow PG-Si-based composite 110 may be referred to generically as a PG-Si-based composite 110. The PG-Si-based composite 110 is suitable for use with anodes of LI-ion batteries.

The silicon deposition 112 may be Si, SiOₓ (x<2) or SiO₂. Where the silicon deposition 112 is Si, the PG-Si-based composite 110 may be referred to as a PG-Si composite. The art of depositing silicon, SiOx, and SiO₂ coatings with controlled thickness, crystallinity and purity is well known to those skilled in the art of chemical vapor deposition (CVD) of silicon, SiOx, and SiO₂. In one example of Si deposition, silane gas is used as the process gas where other carrier and doping gasses may be added. Other deposition methods include plasma enhanced chemical vapor deposition (PECVD) process. This disclosure may interchangeably use the words silicon, SiOx, and SiO₂ interchangeable and without any limitation.

Referring now to FIG. 1C, shown therein is a cross-sectional schematic of a solid PG-Si-based composite 120, according to an embodiment. The solid PG-Si-based composite 120 includes a solid polyhedral graphene nanoparticle 121. The solid polyhedral graphene nanoparticle 121 may be the polyhedral graphene nanoparticle 101 of FIG. 1A. The solid polyhedral graphene nanoparticle 121 does not include a void 114. The solid PG-Si-based composite 120 is otherwise configured similarly to the hollow PG-Si-based composite 110 of FIG. 1B. The solid PG-Si-based composite 120 may be referred to generically as a PG-Si-based composite 110.

Referring to FIG. 2A, shown therein is a cross-sectional schematic of a spherical graphene nanoparticle 201. The spherical graphene nanoparticle 201 is configured as a sphere. The spherical graphene nanoparticle 201 is otherwise configured similarly to the polygonal graphene nanoparticle 101.

Referring now to FIG. 2B, shown therein is a cross-sectional schematic of a hollow SG-Si-based composite 210. The hollow SG-Si-based composite 210 includes a hollow spherical graphene nanoparticle 211. The hollow spherical graphene nanoparticle 211 may be the spherical graphene nanoparticle 201 of FIG. 2A. The spherical hollow SG-Si-based composite 210 is otherwise similarly configured to the hollow PG-Si-based composite 110 of FIG. 1B. The hollow SG-Si-based composite 210 may be referred to generically as a PG-Si-based composite 110.

Referring now to FIG. 2C, shown therein is a cross-sectional schematic of a solid SG-Si-based composite 220, according to an embodiment. The solid SG-Si-based composite 220 includes a solid spherical graphene nanoparticle 221. The spherical graphene nanoparticle 221 may be the spherical graphene nanoparticle 201 of FIG. 2A. The solid SG-Si-based composite 220 is otherwise configured similarly to the solid PG-Si-based composite 120 of FIG. 1C. The solid SG-Si-based composite 220 may be referred to generically as a PG-Si-based composite 110.

A powder composed of multiple PG-Si-based composite nanoparticles 110 is suitable for use with anodes for Li-ion batteries. Any of the PG-Si-Based composites 110, or a combination of more than one PG-Si-Based composites 110, such as the hollow PG-Si-based composite 110, the solid PG-Si-based composite 120, the hollow SG-Si-based composite 210, and the solid SG-Si-based composite 220 may be used as anode for Li-ion batteries. The figures in this disclosure may interchangeably use the spherical and hexagonal or hollow and solid illustration of the polyhedral graphene morphology without any limitation.

One advantage of using PG-Si-based composites 110 as anode material for Li-ion battery is the high mechanical strength of the polyhedral graphene nanoparticle as compared to similar sample made from graphite, carbon or carbon black. High particle strength is needed to keep the silicon coating from fracturing as it expands 200 to 300% during the lithiation process of the anode. Another advantage of the PG-Si-based composites 110 as anode material for Li-ion battery is the high electrical conductivity of the crystalline polyhedral graphene nanoparticle as compared to the electrical conductivity of the amorphous carbon or carbon black.

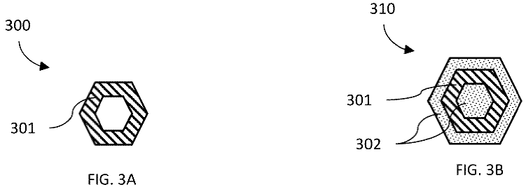

Referring to FIG. 3A, shown therein is a cross-sectional schematic of a hollow polyhedral graphene nanoparticle 300 according to an embodiment. The hollow polyhedral graphene nanoparticle 301 is similarly configured to the to the hollow polyhedral graphene nanoparticle 101 of FIG. 1A.

Referring now to FIG. 3B, shown therein is cross-sectional schematic of a filled PG-Si-based composite 310, according to a further embodiment. The hollow polyhedral graphene nanoparticle 301 is filled and coated with a silicon deposition 302 to form the PG-Si-based composite 310. In some cases, the hollow polyhedral graphene nanoparticle 301 is only partially filled with the silicon disposition 302. In other cases, the polyhedral graphene nanoparticle 301 is only partially coated with the silicon disposition 302. The PG-Si-based composite 310 is otherwise similarly configured to the hollow PG-Si-based composite 110 of FIG. 1B. The filled PG-Si-based composite 300 may be referred to generically as a PG-Si-based composite 110. Interchangeably, SiOₓ (x<2) or SiO₂ filled PG-Si-based composites may also be referred to generically as a PG-Si-based composite 110.

Standard and modified chemical vapor deposition techniques for silicon deposition, such as rate and temperature of deposition, and selection of carrier gasses, may be used to achieve the silicon filling. One way to enable filling the PG void with silicon is to partially open the polyhedral graphene nanoparticles with the help of selective carbon activation.

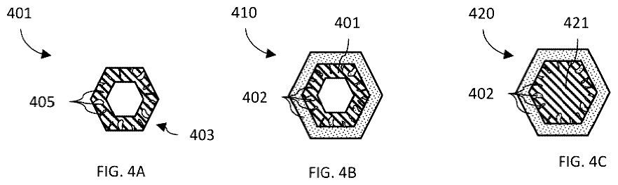

Referring to FIG. 4A shown therein is a cross sectional schematic of a hollow polyhedral graphene nanoparticle 401, according to an embodiment. A graphene shell 403 of the porous polyhedral graphene nanoparticle 401 includes pores 405. The pores 405 can be shallow pores that do not penetrate through the graphene shell 403. The pores 405 may further be deep pores that penetrate the graphene shell 403 and are at parts connected to the void of the graphene nanoparticle 401. The porous polyhedral graphene nanoparticle 401 is otherwise similarly configured to the polyhedral graphene nanoparticle 101 of FIG. 1A.

Referring now to FIGS. 4B and 4C shown therein are cross sectional schematics of porous and coated PG-Si-based composites 410, 420 according to a further embodiments. The porous and coated PG-Si-based composite 410, 420 include a silicon disposition 402 deposited into the pores 405 and on the surface of the porous polyhedral graphene nanoparticle 401 to form the porous and coated PG-Si-based composite 400. The silicon disposition 402 is similarly composed to the silicon disposition 112 of FIG. 1B. In some cases, the pores 405 of the porous polyhedral graphene nanoparticle 401 are only partially filled with silicon. In other cases, the outside surface of the graphene nanoparticle 401 is only partially coated with silicon. The porous polyhedral graphene nanoparticle 401 can be hollow as in porous and coated PG-Si-based composite 410 or solid 421, as in porous and coated PG-Si-based composite 420. Porous and coated PG-Si-based composites 410, 420 are generically referred to as PG-Si-based composite 110.

In one embodiment, the porous graphene shell 403 may be obtained by direct chemical or physical activation process of the polyhedral graphene nanoparticle 401 to produce pores 405 on the graphene. In another embodiment, the porous surface may be obtained by first making a carbon black nanoparticle porous with the help of chemical or physical activation process, followed by a joule heating process that will convert the porous carbon black nanoparticle into porous polyhedral graphene nanoparticle 401.

Chemical activation for producing porosity in carbon and graphene materials is generally conducted at 450-900° C. in the presence of activation agents such as NaOH, KOH, H₃PO₄, ZnCl₂, or FeCl₃ to aid the transformation of solid carbon or graphene into CO₂ and CO gas, creating nanopores 405. In another embodiment, the porous surface may be obtained by physical activation process known to produce pores 405 in a carbon or graphene material. Physical activation process is a gasification process, using agents such as water vapor, CO₂, or O₂ at temperatures in the range of around 300-900 C depending on the agent. In some cases, the graphene surface may have to be first oxidized to create defects on which the activation will work more efficiently. Another method for making porous carbon and graphene materials is the use of oxidizing liquids in a hydrothermal process reaction. Yet another method of making porous carbon and graphene materials is the use of mechanical milling, such a ball milling technique.

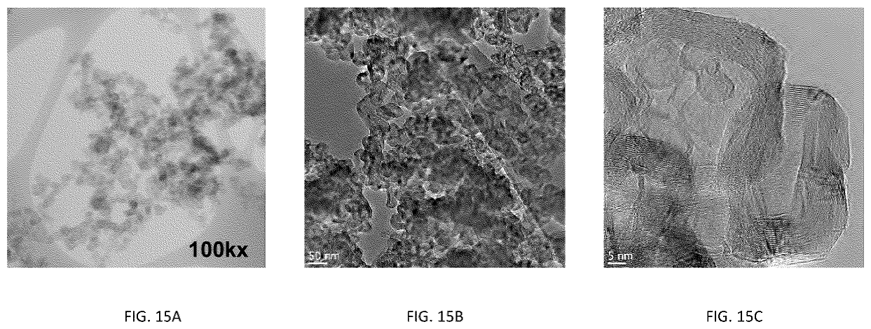

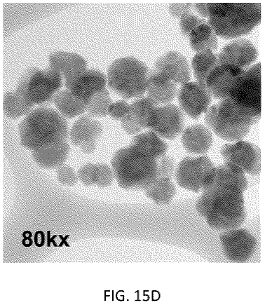

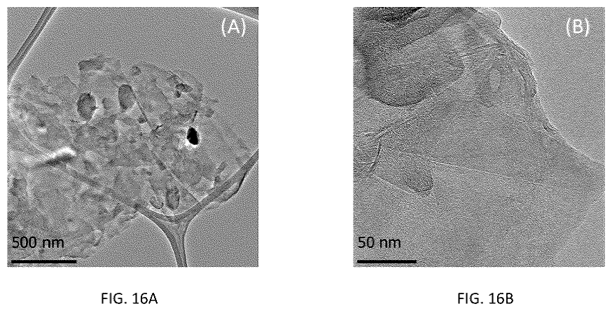

Convenient feedstocks for manufacturing of polyhedral graphene are carbon blacks that come in variety of branching structure, as measured by Oil Absorption Number (OAN) in cc/100 g, and size as measured by Surface Area in m²/g. Majority, if not all, carbon blacks have a spherical morphology and diameter from 20 nm to 300 nm, and they typically form a branching structure that goes from less to more complex and can extend in length from a single CB nanoparticle to few microns long structure. The bond between the CB nanoparticles is structural and hard to break with many industrial milling tools. FIG. 15B, further described below, shows one such example.

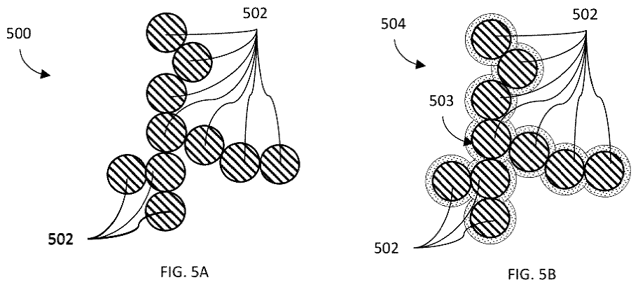

Referring to FIG. 5A, shown therein is a cross sectional schematic of a branched structure 500 according to an embodiment. The polyhedral graphene nanoparticles 502 of the branched structures are structurally joined together. One way of obtaining a branched structure 500 of polyhedral graphene nanoparticles 502 may be by joule heating process that converts a branched carbon black nanoparticle structure into branched polyhedral turbostratic graphene nanoparticle structure of similar shape and morphology as the starting CB material. The polyhedral graphene nanoparticles 502 may be the polyhedral graphene nanoparticles 101, 201, 301 and 401 of FIGS. 1A through 4A. The polyhedral graphene nanoparticles 502 of the branched structure 500 act as a single mechanical structure. The branched structure 500 is electrically conductive among the individual nanoparticles. For illustrative purposes the polyhedral is drawn as sphere.

Referring to FIG. 5B shown therein is a cross sectional schematic of a branched PG-Si composite 504, according to an embodiment. The branched PG-Si composite 504 includes the branched structure 500. The branched PG-Si composite 504 further includes a silicon deposition 502 deposited over an outside surface 503 of the branched structure 500. The structure of the branched PG-Si composite 504 beneficially forms a more mechanically stable anode with better electrical conductivity than an assembly of individual carbon or graphene nanoparticles. The polyhedral graphene nanoparticles 502 can be hollow or solid, porous or not, and coated with Si or SiOₓ (x<2) or SiO₂ or any combination thereof.

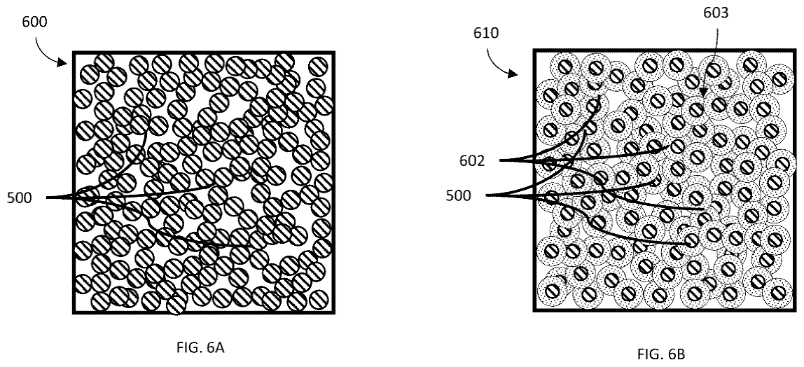

Referring now to FIG. 6A, shown therein is a cross sectional schematic of a an electrically conductive matrix 600, according to an embodiment. The electrically conductive matrix 600 includes multiple branched structures 500. The multiple branched structures 500 of the electrically conductive matrix 600 act as a single mechanical structure. The conductive matrix 600 may be formed by mixing and entanglement of multiple branched structures 500. In some cases, the matrix may be compressed to form better entanglement of the branched structures 500. In some cases, metal based or polymer based bonding may be applied to join the branched structures 500 into matrix 600.

Referring now to FIG. 6B, shown therein is cross sectional schematic of a PG-Si composite matrix 610 according to an embodiment. The PG-Si composite matrix 610 includes a silicon deposition 602 deposited over a surface 603 of the electrically conductive matrix 600. Due to the randomness of the branched structures 500 the matrix in inherently macro porous to allow free flow of ions. The PG-Si composite matrix 610 can be compressed to further increase the density of the battery anode without compromising the flow of electrons or ions. The nanoparticles shown in FIG. 6 can be hollow or solid, porous or not, and coated with Si or SiOₓ (x<2) or SiO₂ and any combination thereof.

Silicon is very promising alternative anode material due to its highest theoretical capacity (4200 mAh g-1). However, during the lithiation/delithiation process the silicon undergoes extreme volume changes, up to 300%, that tend to destroy the silicon. The incorporation of PG-Si composite of this disclosure reduces or eliminates the expansion related problems. However, there are advantages to using alternative silicon materials, such as SiO and SiO₂, in a design of a battery anode so as to compromise high specific capacity of Si for lower material expansion of SiO and SiO₂ or better resistance to unwanted solid electrolyte interphase (SEI) formation with SiO and SiO₂ (Al Ja'farawy, M. S., Hikmah, D. N., Riyadi, U. et al. A Review: The Development of SiO2/C Anode Materials for Lithium-Ion Batteries. J. Electron. Mater. 50, 6667-6687 (2021). https://doi.org/10.1007/s11664-021-09187-x). SiO₂ which has lower expansion volume (100%) compared to Si (300%) and high theoretical capacity (1965 mAh/g). SiO which has expansion volume of 150% and theoretical capacity of 2400 mAh/g. Therefore, there is a need for a composite design that incorporates Si, SiO, SiOₓ (x<2) and SiO₂.

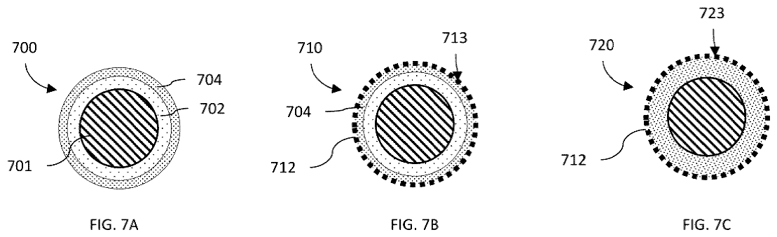

Referring now to FIG. 7A shown therein is a PG-Si—SiO₂ composite 700 according to a further embodiment. The PG-Si—SiO₂ composite 700 includes a PG core 701 coated with an active layer of Si 702 and a protective layer of SiOₓ (x<2) or SiO₂ 704 over the Si active layer 702. The formation of the SiOₓ (x<2) and SiO₂ layer 704 may be achieved by oxidizing or thermal annealing the Si layer 702 or by separate SiO₂ or SiOₓ deposition process, such as CVD or PECVD.

Referring to FIG. 7B, shown therein is a cross sectional schematic of a PG-Si—SiO₂—C composite 710, according to an embodiment. One potential issue with a PG-Si composite nanoparticles is that the contact between two PG-Si composite nanoparticles is one between silicon to silicon or SiO₂ to SiO₂. This contact reduces the electrical conductivity between the nanoparticles. The PGSi-SiO₂—C composite 710 is similarly configured to the PG-Si—SiO₂ composite 700 of FIG. 7A. The PG-Si—SiO₂—C composite 710 further includes a conductive carbon film 712. The conductive carbon film 712 at least partially coats an outer surface 713 of the protective layer of SiOₓ (x<2) or SiO₂ 704. The carbon film 712 beneficially improves the electrical conductivity among PGSi-SiO₂ nanoparticles.

The conductive carbon film can be coated on the PG-Si—SiO₂ composite 700 via acetylene gas heating to form the PG-Si—SiO₂—C composite 710. Mechanical ball milling of the PG-Si—SiO₂ composite 700 with a carbon source (carbon, graphene, PG, carbon nanotubes) is another method of conductive carbon coating. Other methods of carbon coating are also possible.

Referring now to FIG. 7C shown therein is a cross sectional schematic of a PG-Si—C composite 720 according to an embodiment. An outer silicon surface 723 of the PG-Si composite is at least partially coated with the conductive carbon film 712 to form the PG-Si—C composite 720. The conductive carbon film beneficially improves the electrical conductivity among PG-Si nanoparticles. The conductive carbon film 712 may also be implemented with the process and composites described in FIGS. 1A through 6B.

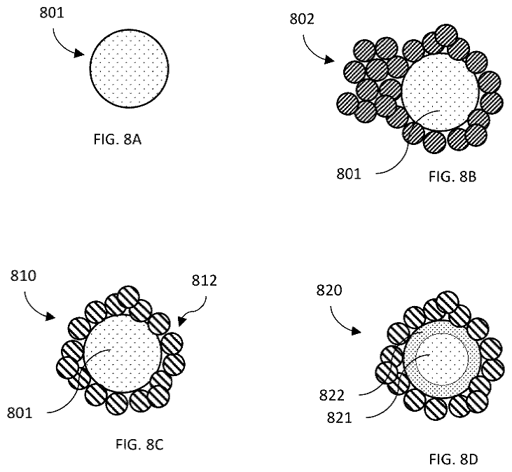

Referring to FIG. 8A shown therein is a cross sectional schematic of a Si nanoparticle 801, according to an embodiment. The Si nanoparticle 801 is composed of Si, SiOₓ (x<2), or SiO₂. The starting Si nanoparticle 801 has a diameter in the range from 5 nm to a few microns. Preferably, the Si nanoparticle is larger than 50 nm and below 500 nm. The Si nanoparticle 801 may be a sphere or some other irregular shape found in nanoparticles and microparticles.

Referring to FIG. 8B, shown therein is the Si nanoparticle 801 covered at least partially with carbon black (CB) nanoparticles 802. Preferably, the diameter of the CB nanoparticles 802 is smaller than the diameter of the Si nanoparticle 801. It is further preferred that the CB nanoparticle 802 diameter is 5× to 10× smaller than the Si nanoparticle 801 diameter. The covering can be achieved by means of mechanical mixing of dry powders, such as ball milling or blade/disk milling.

Referring now to FIGS. 8B and 8C, shown therein is an Si-PG composite 810, according to an embodiment. The Si-PG composite 810 further includes a polyhedral graphene coating 812. The polyhedral graphene coating 812 is over the Si nanoparticle 801. The polyhedral graphene coating 812 is achieved via joule heating process.

The joule heating process includes joule heating of a bulk powder mix of Si and CBs, such as the Si nanoparticle 801 covered with carbon black (CB) nanoparticles 802. In the bulk powder mix, some of the CBs 802 cover the Si nanoparticle 801 and some are in the vicinity of the Si nanoparticle 801. During the flash joule heating process, the CB 802 and Si nanoparticles 801 mix is rapidly heated to more than 2000 C. By this heating, the CB nanoparticles 802 are converted to polyhedral graphene nanoparticles 812. Some PGs 812 at least partially coat the Si nanoparticle 801 and thus create the Si-PG composite 810. Other PGs 812 remain unattached in the mix. The unattached PGs 812 act as an electrically conductive filler. The proportion of attached PGs 812 depends on the ratio of the Si 801 and CB 802 masses. It is preferred that the Si 801: CB 802 mass ratio is between 80:20 and 20:80. The Si core 801 of this embodiment can also be SiO, SiOₓ (x<2) or SiO₂ or any combination thereof.

Referring now to FIG. 8D shown therein is a Si-PG composite 820, according to a further embodiment. The Si core 821 of the Si-PG composite 820 is a composite of a Si core 801 with a SiO, SiOₓ (x<2) or SiO₂ layer 822. This configuration provides the advantage of the SiO and SiO₂ properties described above.

One advantage of using Si-PG composites 820 as anode material for Li-ion battery is the high mechanical strength of the polyhedral graphene shell covering the Si as compared to similar shell covering made from carbon or carbon black. Another advantage is the better electrical conductivity of a graphene compared to carbon or carbon black. Another advantage of the disclosed Si-PG composite 820 over known composites where Si nanoparticles are loosely dispensed over graphene sheets is that the Si and PG are bonded together and can expand and contract together.

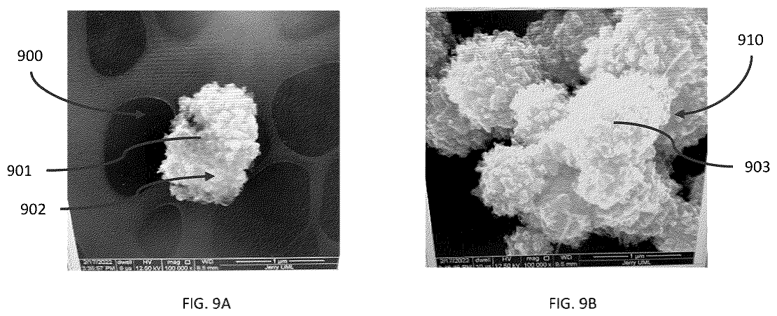

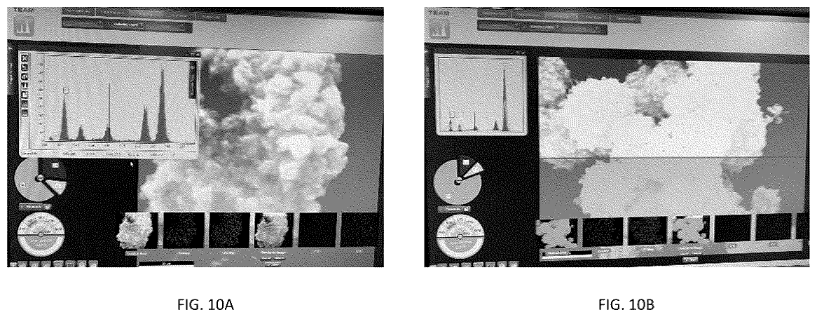

Referring to FIG. 9A, shown therein is an SEM image of an example SiO₂-composite 900, according to an embodiment. The SiO₂-composite 900 is an example of a SiO₂-composite 810 of FIG. 8C. The SiO₂-composite 900 is a single particle of a SiO₂-PG composite. The SiO₂ nanoparticle 901, obscured, was 500 nm and the PGs 902 covering the SiO₂ nanoparticle 901 had average diameter of 40 nm to 60 nm.

Referring now to FIG. 9B shown therein is a cluster SiO₂-PG composite 910. The SiO₂ cluster 903, obscured, comprises of several SiO₂ nanoparticles 901. The cluster 910 of SiO₂-PG composites is obtained by coating the cluster of SiO₂ nanoparticles 903, obscured, with CBs, such as in FIG. 8B. The cluster of SiO₂-PG nanoparticles 910 is further obtained by converting the CBs by a joule heating process, such as in FIG. 8C.

Referring now to FIGS. 10A and 10B shown therein are the result of a EDX analysis of the individual SiO₂-PG composite 900 of FIG. 9A and cluster SiO₂-PG composite 910 of FIG. 9B, respectively. The EDX results show presence of Si, C and O with approximate atomic weight of Si:C:O=65:20:15 in analysis of FIG. 10A and Si:C:O=80:15:5 in analysis of FIG. 10B wherein the dominant atomic mass is silicon. The results indicate that during the joule flashing process some of the SiO₂ was converted to Si and SiC as some of the oxygen was consumed during the process.

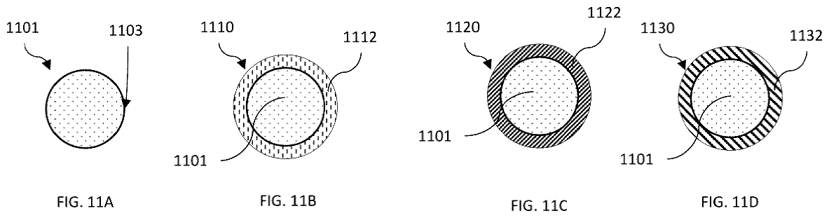

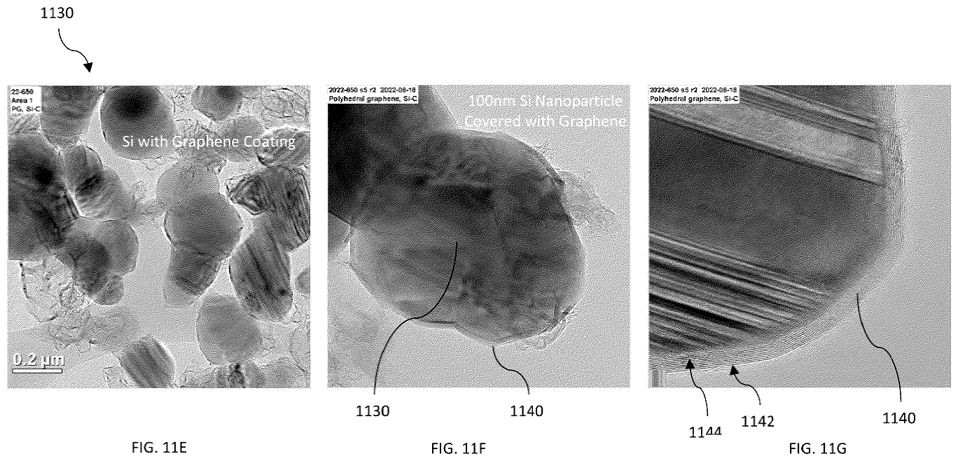

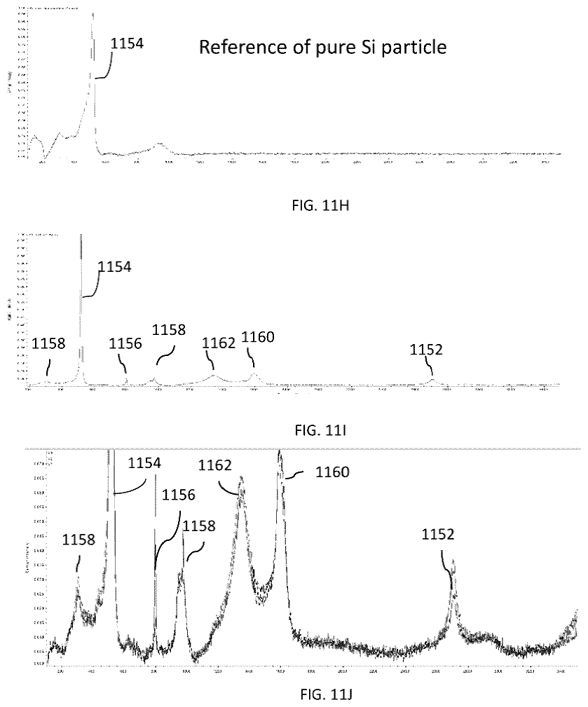

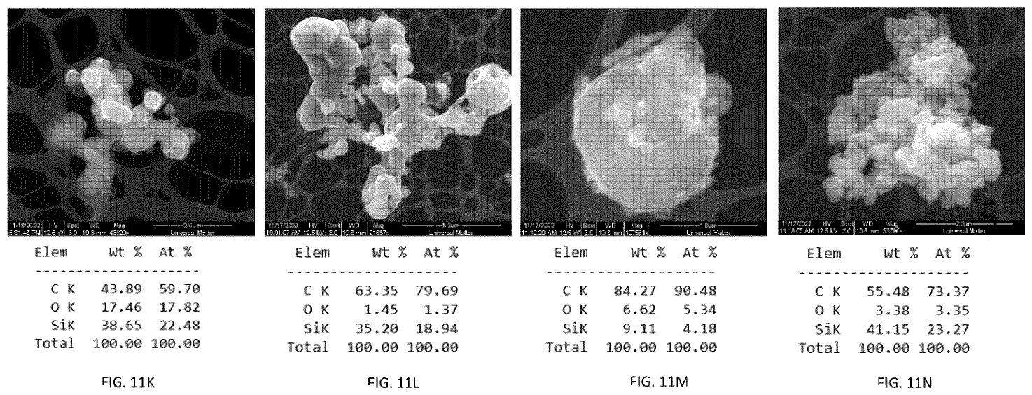

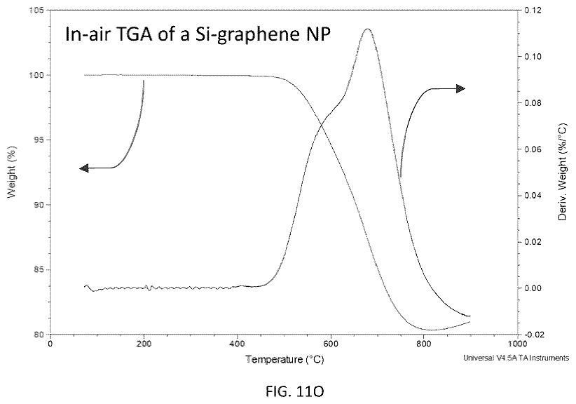

Referring now to FIG. 11A shown therein is a cross sectional schematic of a starting Si nanoparticle 1101, according to an embodiment. The Si nanoparticle 1101 may be the Si nanoparticle 801 of FIG. 8A. The Si nanoparticle 1101 of this embodiment may be 10 to 100 nm in diameter, or it may be 100 to 1000 nm in diameter, or it may be 1 μm to 20 μm in diameter. The silicon nanoparticle 1101 of this embodiment may be in the shape of a sphere, irregular particle, rod, nanowire, or 2D structure. The Si nanoparticle 1101 of this invention may be an isolated particle or an assembly of nanoparticles having branching structure that can extend from 100 nm to few microns in size. A surface 1103 of the Si nanoparticle 1101 may be smooth, nano-porous or microporous.

Referring now to FIG. 11B shown therein is a cross-sectional schematic of a carbon coated Si nanoparticle 1110. Si nanoparticle 1101 is coated with a layer of carbon 1112 over the Si nanoparticle 1101. Depending on the method of carbon deposition the layer of carbon 1112 is predominately amorphous. Amorphous carbon may refer to carbon having low crystalline structure, and/or a high proportion of sp3 carbon. The layer of carbon 1112 will act as the feedstock for a subsequent flash joule heating process that can convert carbon into graphene. To make it suitable for joule heating process the amorphous carbon layer 1112 may be further processed to increase it electrical conductivity, as shown in FIG. 11C. However, if the carbon layer 1112 is sufficiently electrically conductive it may already be suitable for joule heating.

In one example, the coating process step can be achieved by direct formation of carbon 1112 over the Si nanoparticle 1101. An example of direct carbon coating on a Si nanoparticle 1101 is via acetylene gas in a tube oven or rotary oven. Other carbon deposition processes that involve thermal decomposition of carbon from other hydrocarbons or alcohols is also applicable. Another example of direct carbon coating is the use of hydrothermal carbonization of glucose (or sucrose or fructose or other carbohydrates) in a water solution in the presence of Si nanoparticles 1101 in the reactor. In a typical reaction, 5 g glucose is dissolved in 100 ml water with 4 wt.-% Si nanoparticles, in a Teflon lined hydrothermal reactor and heated at 180° C. for 2 h. Removal of the free liquids, filtering of the sludge, and drying the powder will yield a powder of carbon coated Si nanoparticle 1110.

In another example, the carbon coating 1112 can be achieved indirectly by coating of carbon-rich materials over the Si nanoparticle 1101 and then converting the carbon-rich materials into carbon. In some examples, carbon-rich materials may include any material comprising more than 10% carbon content, and includes other materials such as oxygen, hydrogen and nitrogen. Other intermediate process steps that convert the carbon-rich material to a carbon may include liquid and solid dispersion, spray-coat, spin-coat, vapor deposition (high vacuum, low vacuum, chemical or physical), drying or oven heating. An example of carbon-rich coating is a film of polymer or monomer over the Si nanoparticle. One such polymer is acrylic. One may of achieving the coating with a spin coating or spray coating process.

Referring now to FIG. 11C shown therein is a cross-sectional schematic of a pyrolyzed carbon coated Si nanoparticle 1120, according to an embodiment. Making the carbon coated Si nanoparticle 1110 of FIG. 11B suitable for joule heating process where the predominately amorphous carbon is converted into predominately graphene, requires a subsequent pyrolysis process. The subsequent pyrolysis process increases the electrical conductivity of the carbon coating 1112 of FIG. 11B and/or removes non-carbon impurities, organic and mineral impurities, and hydrocarbons. In some examples, the pyrolysis process may increase the carbon content of the coating to an amount greater than that before the pyrolysis process was conducted. The carbon coating 1112 covering the Si nanoparticle 1101 is pyrolyzed in inert atmosphere at 600 to 900° C. for a few hours to yield an electrically conductive carbon coating 1122. The preferred resistivity of the carbon coated Si powder to be suitable for joule heating is in the range from 0.3 to 700 Ohms*cm, as further described in detail in the Patent Cooperation Treaty Application having International Application Number PCT/CA2022/051406 to Mancevski et al., having an international application date of Sep. 21, 2022, which is herein incorporated by reference in its entirety. The electrical conductivity of the carbon coating 1122 can be controlled by the thickness of the carbon layer 1112 before pyrolysis and by the temperature and duration of the pyrolysis. It will be appreciated that where the electrical conductivity of the carbon layer 1112 is within the parameters needed for joule heating the carbon coated Si nanoparticle 1110 of FIG. 11B may not be pyrolyzed.

Referring now to FIG. 11D shown therein is a cross-sectional schematic of a silicon-turbostratic graphene (Si-TG) composite 1130. The Si-TG composite 1130 is obtained by joule heating a bulk powder of the conductive carbon coated Si nanoparticles 1120 of FIG. 11C. The joule heating converts the pyrolyzed carbon layer 1122 of FIG. 11C into a turbostratic graphene (TG) layer 1132 covering the surface of the Si nanoparticle 1101 to create the Si-TG composite 1130. The TG layer 1132 may be a single continuous layer or multiple overlapping layers. The thickness of the TG layer 1132 depends on the thickness of the pyrolyzed carbon layer 1122 of FIG. 11C. The TG layer 1132 can be single layer graphene, few layer graphene or multi-layer graphene with wall thickness from <1 nm to 100 nm. Furthermore, the TG layer 1132 may be a single domain or multi-domain crystal.

In an embodiment, the Si nanoparticle 1101 and the TG layer 1132 of the Si-TG composite 1130 are bonded together so that they can expand and contract together. In another configuration, the Si nanoparticle 1101 and the TG layer 1132 are not bonded together so that the Si nanoparticle 1101 can move with respect to the TG layer 1132.

The TG layer 1132 may be doped with Nitrogen to make it more electrically conductive. The nitrogen doping can be achieved directly by conducting the joule heating in a nitrogen-rich environment. Such a nitrogen-rich environment can be a gas atmosphere of N₂, NH₃, N₂O, NO, NOx or other gas phase nitro compound. The environment can be pure or a mixture of different nitro compounds, or a mixture of nitro compounds with other inert gases such as Ar or He. Adjusting the concentration of nitrogen gas in inert gas may tune the nitrogen doping level in TG layer 1132. The nitrogen doping can also be done by incorporating in the carbon coating 1122 of FIG. 11C, materials that produce nitrogen as they decompose at high temperatures. One such material is glucosamine, as the source of N-doped carbons, that can be used in a hydrothermal carbonization to coat the Si nanoparticle 1101 with a nitrogen rich carbon layer. Other examples can be urea, melamine, cyanamide, amino acids, proteins, chitin, etc.

Referring now to FIGS. 11E, 11F, and 11G shown therein are TEM micrograph images of example Si-TG composite nanoparticles 1130 of FIG. 11D, according to an embodiment. The example Si-TG composite nanoparticles 1130 were fabricated as described above. In this example, 100 nm diameter Si nanoparticles were coated with carbon by means of hydrothermal carbonization of table sugar as described above. The Si-carbon composite was pyrolyzed in an oven at 850° C. for 1 hr. The resulting Si pyrolyzed carbon was joule heated in a quartz tube to convert the carbon into graphene. Details of the joule heating process are disclosed in PCT/CA2022/051406 to Mancevski et al. The resulting Si-TG composite includes a Si nanoparticle (not directly visible because of the graphene layer covering it) and a graphene layer 1140 (cross section view which is possible at the edge of the composite particle). About 10 graphene layers 1142 are shown as included in the graphene 1140. The graphene layer 1140 coats the Si nanoparticles uniformly. Close look at the graphene layers in 1142 shows bright and dark lines that indicate each of the 10 graphene layer and the separation between them. These bright and dark lines in 1144 indicate the crystalline nature of the graphene and the number of graphene layers.

Referring now to FIGS. 11H, 11I, and 11J, shown therein are Raman plots verifying the crystalline structure of the Si and the graphene in the Si-TG composite. Raman microscopy was utilized to verify the crystalline structure of a Si-TG composite from the example Si-TG composite from FIGS. 11E, 11F, and 11G.

FIG. 11I shows a Raman plot of a Si-graphene sample, indicating the presence of a graphene peak (2D peaks indicating well defined graphene structure) 1152 as well as presence of a Si peak 1154 as well as some presence of SiC peaks 1156 and SiO₂ peaks 1158. The G peak 1160 of the Raman signature is the primary mode in graphene and graphite. The G peak 1160 represents the planar configuration sp2 bonded carbon that constitutes graphene. The D peak 1162 of the Raman signature is known as the disorder band or the defect band. The D peak 1162 represents the presence of defects in the graphene. The Raman peaks 1152, 1154, 1156, and 1158 confirm the unique structure of the Si-TG composite in this example. The SiC and SiO₂ were formed during the joule heating process. FIG. 11J shows magnified view of the Raman peaks 1152, 1154, 1156, 1158, 1160, and 1162 of three different material samples overlayed. FIG. 11H shows a Raman signature of the pure Si nanoparticle before it was processed.

Referring now to FIGS. 11K through 11N shown therein are SEM images with EDX analysis results of an example Si-TG composite prepared with the disclosed process steps, according to a further embodiment. The starting Si nanoparticles in this example have an average diameter of 1 μm. The SEM images show that the Si-TG composite can be individual nanoparticle (FIG. 11M) or can form an assembly of branched structure (FIGS. 11K, 11L, and 11N). The EDX results show presence of Si, C and O with carbon loading range from 43 to 63% for the branched structures and about 84% for the individual composite. The Si loading was from 35 to 41% for the branched structures and about 9% for the individual composite, for the average Si-TG composites of this example. Presence of O indicates the presence of SiO₂ in the structure of the composite material.

Referring now to FIG. 11O, shown therein is a thermogravimetric analysis (TGA) plot of an example Si-TG composite prepared with the disclosed process steps. The TGA determines the composition of the Si-TG composite is with thermogravimetric analysis (TGA). The starting Si nanoparticles in this example have an average diameter of 1 μm. The results show Si loading of 81% Si and 19% graphene. The process steps of the current disclosure can produce a Si-TG composite with Si loading from below 5% and up to 95%. The advantage of this high Si loading is the construction of a battery anode with very high Si loading. This loading is beneficially higher than what is achievable by means of the current state-of-the-art of Si battery anode fabrication such as fabrication that mixes Si nanoparticles with loose graphene sheets.

One advantage of the Si-TG composite as anode material for Li-ion battery is the high mechanical strength of the graphene layer covering the Si compared to a similar shell covering made from non-crystalline carbon. Another advantage is the better electrical conductivity of a graphene compared to carbon or carbon black. Another advantage of the disclosed Si-TG composite over known composites, where Si nanoparticles are loosely dispensed over graphene sheets, is that the TG coating protects the Si from degradation due to repeat SEI formation and electrical contact loss.

One potential problem that may arise during the formation of the graphene coating, PG or TG, is that the exposure of the Si nanoparticle at the high temperatures generated by the joule heating process, from 900 C to above 2000 C, is that the Si may form SiC layer at the interface between the Si and the graphene. This layer may reduce the electrical conductivity of the Si-Graphene composites. However, if the resulting SiC material is beta-SiC, which is known to have lithium storing capabilities, the composite is suitable for battery applications. The SiC formation may be reduced when the core particle is SiO₂ nanoparticle instead of Si. Another means of reducing the SiC presence in this invention is to conduct the joule heating of the carbon source in a presence of a CO₂ gas which has shown to suppress SiC formation during a growth of graphene via prior art CVD methods. The CO₂ can be injected into the joule heating reactor as a gas or it can be delivered via other materials that produce CO₂ as they decompose at high temperatures. One such material is Calcium Acetate, Ca(OAc)₂, that at higher temperatures forms CO₂ that reduces the SiC formation on the surface of the Si nanoparticle. Calcium Acetate will at the same time make the carbon or graphene present in the Si-carbon or Si-graphene composite porous as well.

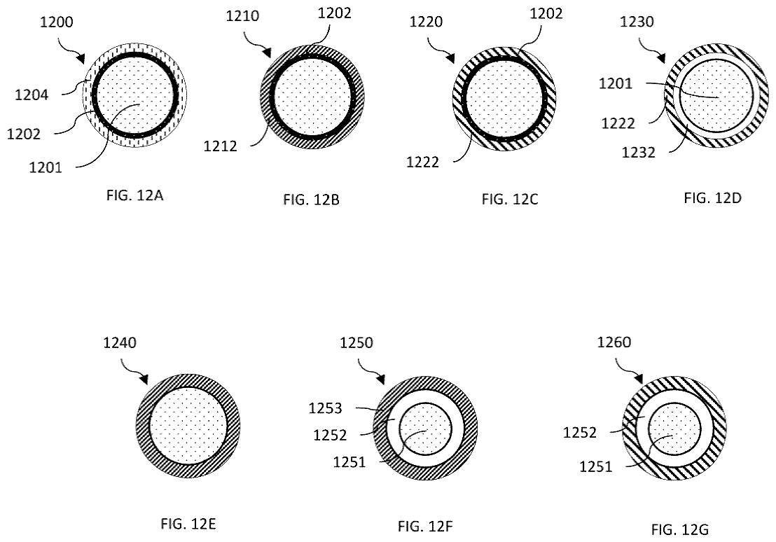

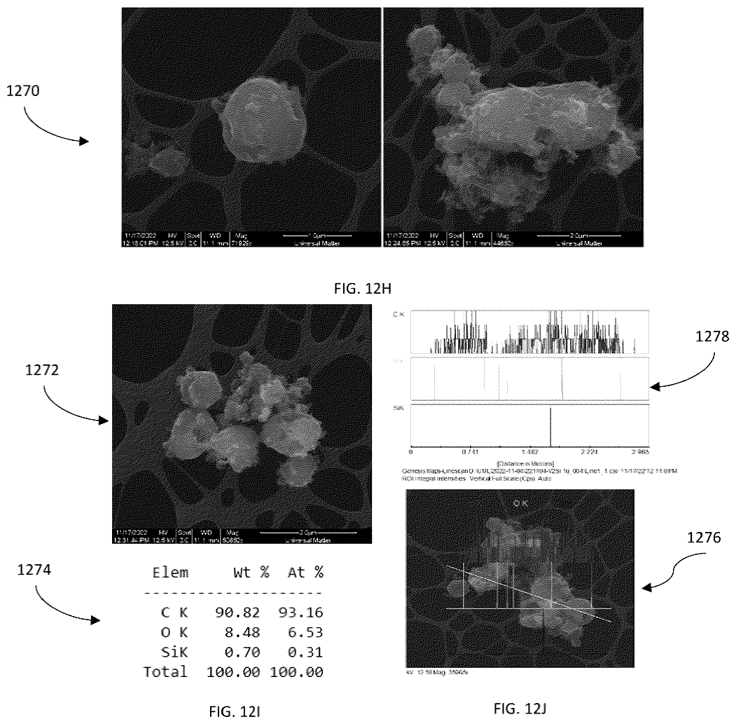

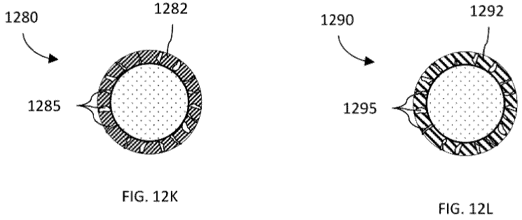

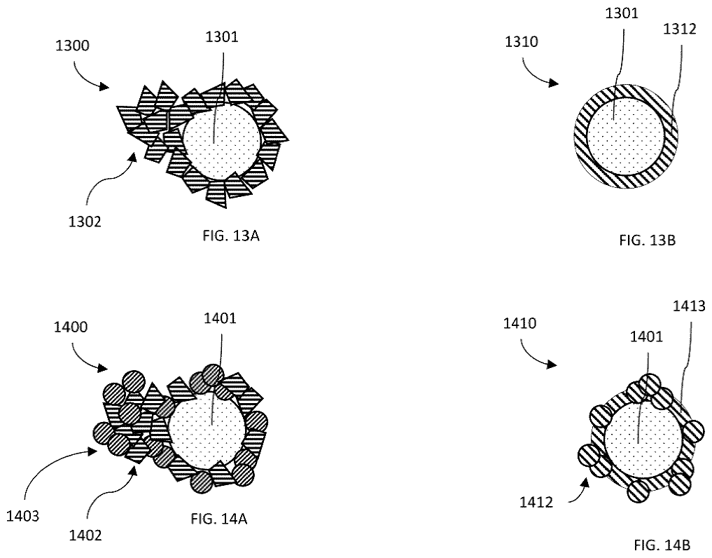

Referring now to FIG. 12A, shown therein is a cross-sectional schematic of a coated Si nanoparticle 1200, according to an embodiment. The coated Si nanoparticle 1200 includes an Si nanoparticle 1201. The Si nanoparticle is configured similarly to the Si nanoparticle 801 of FIG. 8A. The coated Si nanoparticle 1200 further includes a sacrificial layer 1202. The sacrificial layer 1202 is disposed proximally to the Si nanoparticle 1201 and is in contact with the Si nanoparticle 1201. The sacrificial layer is configured and composed to prevent the interaction of carbon with the Si of the Si nanoparticle 1200 at high temperatures. The coated Si nanoparticle 1200 further includes a carbon layer 1204. The carbon layer 1204 coats the coated Si nanoparticle 1200 with carbon. The carbon layer 1204 is disposed outside the sacrificial layer 1202 such that the sacrificial layer 1202 is disposed between the Si nanoparticle 1201 and the carbon layer 1204. In one example the sacrificial layer 1202 is silicon oxide onto a silicon nanoparticle 1201. In a further example, the sacrificial layer 1202 is a plasma treated on the surface of the Si nanoparticle 1201 to produce an oxidized surface. The sacrificial layer can also be metal, such as Nickel, that can be deposited by electroless means to the Si nanoparticle 1201. Other sacrificial layers 1201 may include dielectric or inorganic coatings.

Referring now to FIG. 12B shown therein cross-sectional schematic of a pyrolyzed carbon coated Si nanoparticle 1210, according to an embodiment. The pyrolyzed carbon coated Si nanoparticle 1210 includes a pyrolyzed carbon layer 1212 over the sacrificial layer 1202. The pyrolyzed carbon layer 1212 is an electrically conductive carbon. The pyrolyzed carbon layer 1212 is obtained by pyrolyzing the carbon layer 1204 of FIG. 12A. The pyrolyzed carbon coated Si nanoparticle 1210 is otherwise similarly configured to the coated Si nanoparticle 1200.

Referring now to FIGS. 12B and 12C, shown therein is a cross-sectional schematic of a turbostratic graphene coated Si nanoparticle 1220, according to an embodiment. The turbostratic graphene coated Si nanoparticle 1220 includes a turbostratic graphene layer 1222. The turbostratic graphene layer 1222 is obtained by joule heating the pyrolyzed carbon coated Si nanoparticles 1210 to convert the pyrolyzed carbon layer 1212 into the turbostratic graphene layer 1222 covering the outer surface of the sacrificial layer (SL) 1202. The turbostratic graphene coated Si nanoparticle 1220 is otherwise similarly configured to the pyrolyzed carbon coated Si nanoparticle 1210.

Referring now to FIG. 12D, shown therein is a cross sectional schematic of a Si-Void-TG nanoparticle 1230, according to an embodiment. The Si-Void-TG nanoparticle 1230 includes a void 1232. The void 1232 is a space absent solid matter. The void is disposed between the turbostratic graphene layer 1222 and the Si nanoparticle 1201. In some configurations the void does not have be complete, some contact between the graphene layer 1222 and the Si nanoparticle 1201 is present. The void 1232 is obtained by washing the sacrificial layer 1202 of FIG. 12C to remove the sacrificial layer 1202. The sacrificial layer 1202 is washed with a base, acid or solvent depending on the chemistry of the sacrificial layer 1202. In one example a SiO₂ sacrificial layer 1202 is removed with 2M NaOH solution for 1 hr immersion with stirring. In another example a Ni sacrificial layer is removed with diluted HCl acid. Void helps the Si nanoparticle 1201 expand during lithiation/delithiation process without overstressing the graphene layer 1222.

Referring now to FIG. 12E, shown therein is a cross-sectional schematic of a pyrolyzed carbon coated Si nanoparticle 1240, according to an embodiment. The pyrolyzed carbon coated Si nanoparticle 1240 is similarly configured to the pyrolyzed carbon coated Si nanoparticle 1120 of FIG. 11C.

Referring now to FIG. 12F shown therein is a cross-sectional schematic of a pyrolyzed carbon voided Si nanoparticle 1250, according to an embodiment. The pyrolyzed carbon voided Si nanoparticle 1250 includes a void 1252. The void 1252 is a space absent solid matter. The void 1252 is disposed between a Si nanoparticle 1251 and a pyrolyzed carbon layer 1253. The void 1252 is obtained by subjecting the Pyrolyzed carbon coated Si nanoparticle 1240 of FIG. 12E to an etching process so as to reduce the diameter of the Si core 1251. This reduction in diameter leaves the void 1252 space between the Si nanoparticle 1251 and the pyrolyzed carbon shell 1253. In some configurations the void does not have be complete, some contact between the pyrolyzed carbon shell 1253 and the Si nanoparticle 1251 is present. The pyrolyzed carbon voided Si nanoparticle 1250 is otherwise similarly configured to the pyrolyzed carbon coated Si nanoparticle 1240 of FIG. 12E. One method of etching the Si core 1251 is with 2M NaOH solution for a set period of time. The period of time can be used to control the new Si nanoparticle 1251 size and therefore the void 1252 size.

Referring now to FIG. 12G, shown therein is a cross-sectional schematic of a Si-Void-TG nanoparticle 1260, according to an embodiment. The Si-Void-TG nanoparticle 1260 is configured similarly to the Si-Void-TG nanoparticle 1230 of FIG. 12D. The Si-Void-TG nanoparticle 1260 is obtained by converting the pyrolyzed carbon coating 1253 to graphene layer via joule heating. The void will help reduce the formation of SiC on the Si nanoparticle 1251 during the joule heating process. The void between the Si and the graphene in the Si-Void-TG composite will help contain the Si expansion during lithiation/delithiation process.

In an embodiment, the Si nanoparticle core 1251 is completely etched away. In this embodiment, the void 1252 includes the full space that the Si nanoparticle 1251 occupied. Here the graphene structure of the pyrolyzed carbon layer 1253 forms an empty shell of pyrolyzed carbon 1250. For clarity, empty is understood to be a substantial absence of solid matter. In embodiments the empty pyrolyzed carbon shell 1250 can be converted to an empty TG shell 1260 with the help of joule heating process.

Referring now to FIG. 12H shown therein is an SEM image of example empty graphene shells 1270, according to an embodiment. The graphene shells 1270 are Void-TG shells such as the Si-Void-TG nanoparticle 1260 where the Si nanoparticle core 1251 is fully etched out. The example graphene shells 1270 are of made from 1 μm average diameter Si nanoparticle sacrificial cores, not pictured. The Si core may be removed while the Si core is coated with carbon, pyrolyzed carbon or graphene to form the shell structure. If the shell is initially carbon or pyrolyzed carbon then an additional process step of joule heating will convert the carbo into graphene.

Referring now to FIG. 12I, shown therein is an SEM image 1272 and the corresponding EDX map 1274 of an example TG-shell, according to an embodiment. The EDX map 1274 indicates a measured presence of C and O and <1% of Si presence.

Referring now to FIG. 12J shown therein is an SEM image 1276 and the corresponding EDX trace 1278 of an example TG-shell structure, according to an embodiment. The EDX trace 1278 indicates the almost complete lack of Si and the presence of C and some O. In an embodiment, the empty TG shell may be back filled with Li, Na, Sn, or other metals or CO₂, H₂, or other gases. In a further embodiment, the core of the sacrificial material may be composed of metal or oxide.

Referring now to FIG. 12K, shown therein is a pyrolyzed carbon coated Si nanoparticle 1280, according to an embodiment. The pyrolyzed carbon coated Si nanoparticle 1280 includes a pyrolyzed carbon coating 1282. The pyrolyzed carbon coating 1282 includes pores 1285. The pyrolyzed carbon coated Si nanoparticle 1280 is otherwise similarly configured to the pyrolyzed carbon coated Si nanoparticle 1120 of FIG. 11C. The pyrolyzed carbon coated Si nanoparticle 1280 may be made porous by chemical activation process which is generally conducted at 450-900° C. in the presence of activation agents such as NaOH, KOH, H₃PO₄, ZnCl₂, FeCl₃, or Ca(OAc)₂, or other activation agents that are well-known in activated carbon industry.

Referring now to FIG. 12L, shown therein is a Si-porous-graphene (Si-pTG composite 1290. The Si-pTG composite 1290 includes a graphene layer 1292. The graphene outer layer 1292 includes pores 1295. The Si-pTG composite 1290 is otherwise similarly configured and compose as the pyrolyzed carbon coated Si nanoparticle 1280 of FIG. 12K. In an embodiment, the Si-pTG composite 1290 is obtained by converting a porous carbon coating 1282 of FIG. 12K to a porous graphene 1292 with a joule heating process. In a further embodiment, the Si-pTG composite 1290 is obtained subjecting an Si-TG composite 1130 of FIG. 11D to a chemical activation process to make pores 1295 into the graphene. The pores 1295 may be nanopores, mesopores, or micropores. The presence of pores in the graphene will help Li transport from an electrolyte to the Si and vice versa.

Alternative method of adding porosity to the graphene layer 1292 of the Si-graphene composite 1290 is by mechanical methods such as ball milling (vertical or horizontal mill) or speedmixer milling (with balls and just the powder by itself). The ball mill requires the use of small hard balls mixed with the milled powder in sealed jars where the amount of surface damage by which the pores are formed depends on the time of milling, the ratio of balls to powder and loading ratios. With a speedmixer the use of the balls is optional as the powder itself can be used to damage the composite surface and create pores. The mechanical pore formation creates shallow pores. For deeper pore formation the mechanical milling can be followed up with a chemical activation process.

Referring now to FIG. 13A shown therein is cross-sectional schematic of a starting mix 1300, according to an embodiment. The starting mix 1300 includes an Si nanoparticle 1301 and carbon particles 1302. The starting mix 1300 is otherwise similarly configured and composed as the Si nanoparticle 801 covered with carbon black (CB) nanoparticles 802 of FIG. 8B.

It is preferred but not required that the carbon particle 1302 sizes are smaller than the Si nanoparticle 1301. Example carbon particles 1302 include MetCoke, PetCoke, Bio Char, Plastic Char, and other common carbon sources used with joule heating and are likely to produce flake-like graphene morphology. The starting mix 1300 can be achieved by means of mechanical mixing of dry powders, such as ball milling or blade/disk milling.

Referring now to FIG. 13B, shown therein is cross-sectional schematic of a silicon and flake-like turbostratic graphene (Si-FTG) composite 1310, according to an embodiment. The Si-FTG composite 1310 is obtain by applying a flash joule heating process to the bulk powder 1300 of FIG. 13A. Applying the flash joule heating will result in rapidly heated the mix to above 2000 C, where the carbon particles 1302 are converted to flake-like graphene 1312. Some FTGs 1312 at least partially coat the Si nanoparticle 1301 and thus create the Si-FTG composite 1310. Where some FTGs 1312 remain unattached in the mix the unattached FTGs act as an electrically conductive filler. The proportion of attached FTGs 1312 to unattached FTGs 1312 depend on the ratio of the Si 1301 and carbon masses 1302 of FIG. 13A. It is preferred that the Si:C mass ratio is between 80:20 and 20:80. The Si core 1301 of this embodiment can also be SiO, SiOₓ (x<2) or SiO₂ or any combination thereof.

Referring now to FIG. 14A, shown therein is a further starting mix 1400, according to an embodiment. The starting mix 1400 includes a Si nanoparticle 1401, carbon blacks (CBs) 1402, and carbon particles 1403 such as coke or char. The starting mix 1400 is otherwise similarly configured and composed as the starting mix 1300.

Referring to FIG. 14B, shown therein is a cross-sectional schematic of a silicon and polyhedral-like and flake-like turbostratic graphene (Si-PG-FTG) composite 1410, according to an embodiment. The Si-PG-FTG composite 1410 is obtained by applying a flash joule heating process to the bulk powder starting mix 1400 of FIG. 14A. The carbon particles 1403 are converted to FTG 1413, and CB nanoparticles 1402 are converted to PG 1412. Some fraction of FTGs 1413 and PGs 1412 at least partially coat the Si nanoparticle 1401.

Referring to FIGS. 15A, 15B and 15C, shown therein is a high resolution TEM image of example hollow polyhedral-like graphene nanoparticles, according to various embodiments. The hollow polyhedral-like graphene nanoparticles include 3 to 50 layers of graphene. Polyhedral graphene nanoparticles can self-organize in a branched structure made from multiple PG nanoparticles, ranging in length from few nm to few microns, as shown in FIG. 15A.

Referring to FIG. 15D shown therein is a high resolution TEM image of not-hollow (solid) polyhedral graphene nanoparticles, according to an embodiment. The not-hollow (solid) polyhedral graphene nanoparticles do not include a void in the nanoparticle.

Referring to FIGS. 16A and 16B shown therein are TEM images of is an example of a flake-like graphene, according to various embodiments. Typical FTG graphene range from 100 nm to 2 μm in lateral size and from 2 graphene layers to more than 10 layers in thickness. Polyhedral graphene is a closed form of graphene that forms a polyhedral cage, wherein multiple cages are nested within each other. Spherical cages are also possible. In some cases, the polyhedral graphene nanoparticles can have a void (they are hollow) and on some cases, they are solid (there is no void). Typical PG graphene ranges from 20 nm to 200 nm in (diameter) size and has from 2 to more than 50 layers wall thickness.

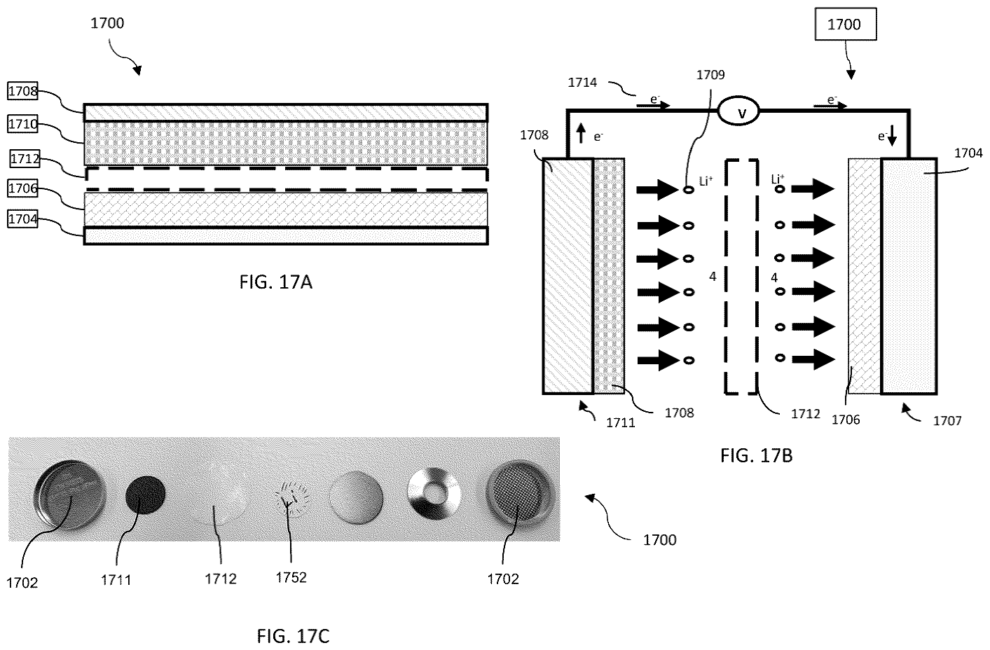

Referring to FIGS. 17A and 17B, shown therein are cross-sectional schematics of a Li Ion battery 1700, according to various embodiments. FIG. 17B shows the Li Ion battery 1700 in discharge operations.

The lithium-ion battery cell 1700 includes an outer housing 1702. The outer housing 1702 may be a metal housing or a polymer casing depending on the type of cell. The outer housing 1702 houses the remaining components, further described below.

The Li Ion battery 1700 further includes an aluminum foil current collector 1704 and a cathode material 1706. The cathode material 1706 is disposed on the aluminum foil 1704 (i.e., positive cathode electrode 1707). The cathode 1707 is typically made from lithium-metal oxide materials, such as lithium cobalt oxide (LiCoO₂), Li(Ni_{0.6}Mn_{0.2}Co_{0.2})O₂ (NMC622).

The Li Ion Battery further includes a copper foil current collector 1708 and an anode material 1710. The anode material 1710 is disposed on the copper foil (i.e., negative anode electrode 1711). The Si-graphene composite material disclosed herein is used as material for the anode material 1710. Known anodes 1711 are made of graphite, or composites such as Silicon-carbon, Tin-carbon. The anode 1711 of this disclosure is made from the Si-graphene composites disclosed here.

The Li Ion Battery 1700 further includes a separator 1712. The separator 1712 is disposed between the electrodes 1707, 1711. The separator 1712 electrically separates the anode 1711 and cathode 1707 while permitting lithium ions 1709 to pass through the separator 1712. The separator 1712 is a porous polymer membrane. The separator 1712 is made of a single or several layers of polymers such as Polypropylene, Polyethylene.

The cathode electrode 1707, anode electrode 1711, and separator membrane 1712 are submerged in a solvent that acts as an electrolyte. Typical liquid electrolytes in lithium-ion batteries include lithium salts, such as lithium hexafluorophosphate (LiPF₆), in an organic solvent, such as a mixture of ethylene carbonate, dimethyl carbonate, and diethyl carbonate. Additional electrolyte additives such as fluoroethylene carbonate (FEC) are added to obtain favorable solid electrolyte interface (SEI) layer for long-term stability.

During the charging process (i.e., charging the battery), lithium ions 1709 move through the electrolyte from the cathode 1707 to the anode 1711. The lithium ions are stored in the anode 1711 via different mechanisms such as intercalation (graphite anodes), or alloying (Silicon based anodes).

During the discharging process (i.e., the battery 1700 powers a load), the lithium ions move back through the electrolyte from the anode 1711 to the cathode 1707. This movement of lithium ions 1709 causes electrons 1714 to move in the opposite direction in the outside electrical circuit, thus powering the load. Charging the lithium-ion battery is reversed of the above discharging process. During charging, the external voltage forces the lithium ions 1709 to move back to the anode 1711, while electrons 1714 move back to the anode 1711 via the outside electrical circuit.

In a known electrode fabrication, the anode 1711 and cathode 1707 electrodes are made from casting slurries on the corresponding current collectors. For example, a typical anode slurry includes the active material (e.g., graphite, Silicon-carbon composites), a binder (e.g., polyvinylidene fluoride, carboxymethyl cellulose), conductive carbon (e.g., Super P), and a solvent (e.g., water, n-methyl-2-pyrrolidone). The coated films are then dried in oven at 60° C.-80° C. for 12 hours. Coin cells are typically made in 2032 configuration (button battery). The cells are assembled inside an Argon-filled glovebox with low water and oxygen contents (e.g., <1 ppm).

Referring to FIG. 17C, shown therein is an image of an example a Li-ion battery 1750 of this invention. The Li-ion battery 1750 was tested in a half-cell configuration.

The half-cell fabrication includes a Lithium metal foil 1752. The Lithium metal foil 1752 is configured as pseudo-reference electrode instead of a cathode electrode. The coin cells were cycled (charging/discharging) between 1.5 V and 0.005 V at different C rates (current densities). Additional electrochemical measurements sometimes also employed to further characterize the battery performance.

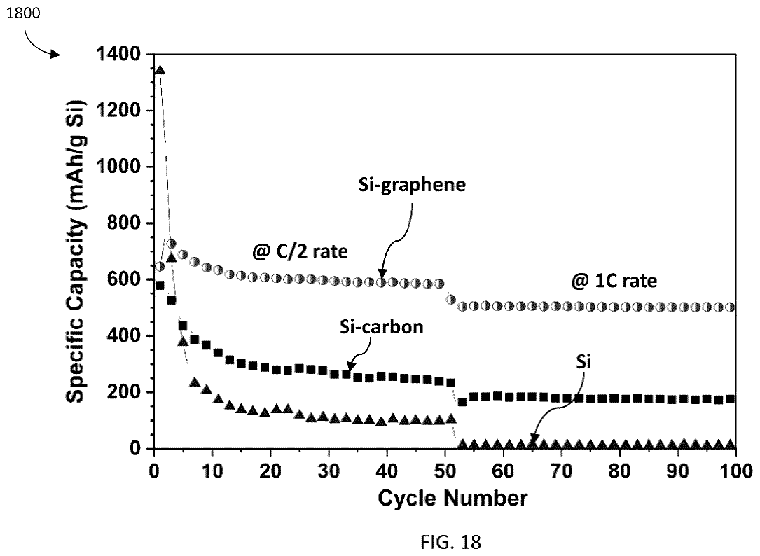

Referring to FIG. 18 shown therein is a plot 1800 of example results of testing a Si-graphene composite 1130 of FIG. 11D. The Si particles 1101 of FIG. 11D had a 1 μm average diameter. The plot 1800 compares the Si-graphene composite 1130 performance to Si-pyrolyzed-carbon composite and pure Si material. In this test the battery was operated at C/2 for the first 50 cycles, followed by 1C rate for the second 50 cycles, where 1C=4.2 mA/mg Si. The cell with the composite Si-graphene had a stable capacity of ˜600 mAh/g at C/2 and ˜500 mAh/g at 1 C. For comparison, the cell with Si-pyrolyzed-carbon composite started at a capacity of 600 mAh/g that decreased down to ˜250 mAh/g at C/2 and even further to ˜200 mAh/g at 1 C. The Si only cell had a first cycle capacity of ˜1400 mAh/g but dropped rapidly to ˜100 at C/2 and ˜10 at 1 C, and died after 100 cycles. The results demonstrate the benefit of the graphene coated Si which prevents the Si particle from decomposition.

The composites disclosed in this invention may also be suitable to be used as performance enhancing additives in the making of cement and concrete applications, in making of rubber and tire composites, in making of plastics and polymer composites, and in making lubricants. In some applications, like rubber and tire the preferred composite is silica-graphene.

Although the disclosed invention was described with silicon based nanoparticles, other non-silicon particles may be used to practice the disclosed invention. Other non-silicon particles may be the anode materials such as titanium oxide, vanadium oxide, niobium oxide, molybdenum oxide, tungsten oxide, or transition metal carbide, such as titanium carbide, vanadium carbide, niobium carbide, molybdenum carbide, tungsten carbide, or metals that alloy with Li, such as aluminum, bismuth, cadmium, magnesium, tin, antimony. Other non-silicon particles may be the cathode based materials such as Lithium Cobalt Oxide (LiCoO2)-LCO, Lithium Manganese Oxide (LiMn2O4)-LMO, Lithium Nickel Manganese Cobalt Oxide (LiNiMnCoO2)-NMC, Lithium Iron Phosphate (LiFePO4)-LFP, Lithium Nickel Cobalt Aluminum Oxide (LiNiCoAlO2)-NCA, Lithium Titanate (Li2TiO3)-LTO, and Sulfur(S), but not limited to the group. Other non-silicon particles may be metals such as Pt, Pd, Ru, Au, Ir, Rh, Co, Fe, Cu, Ni, Zn, Bi, or other transition or main group metals; Pt(acac)2, AuCl3, AgNO3 or other metal precursors, TiO2, Al2O3, SiO2 or other oxides or combinations of any of the above. Other non-silicon particles may be catalysts such as Fe, Co, Ni, Cu, or other transition metals; iron acetate, iron chloride, iron acetylacetonate, or other metal salt; iron oxide, cobalt oxide, or other transition metal oxide, iron hydroxide, nickel hydroxide or other transition metal hydroxide, TiO2, Al2O3, SiO2 or other oxides, or any combination of the above.

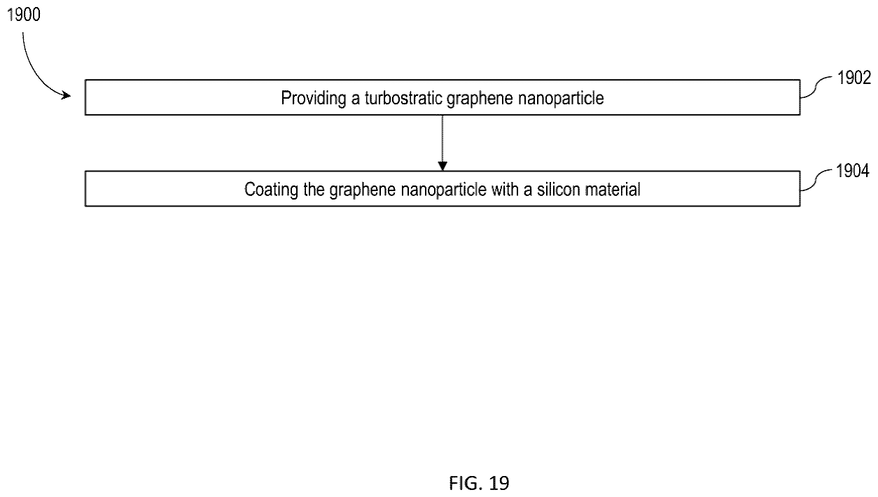

Referring now to FIG. 19, pictured therein is a flow chart describing a method 1900 of producing a silicon graphene composite material, according to an embodiment. Method 1900 includes steps 1902 and 1904. Method 1900 may be used to produce composite materials, for example, materials depicted in FIGS. 1-10.
At 1902, a turbostratic graphene nanoparticle is provided.
At 1904, the graphene nanoparticle is coated with a silicon material.

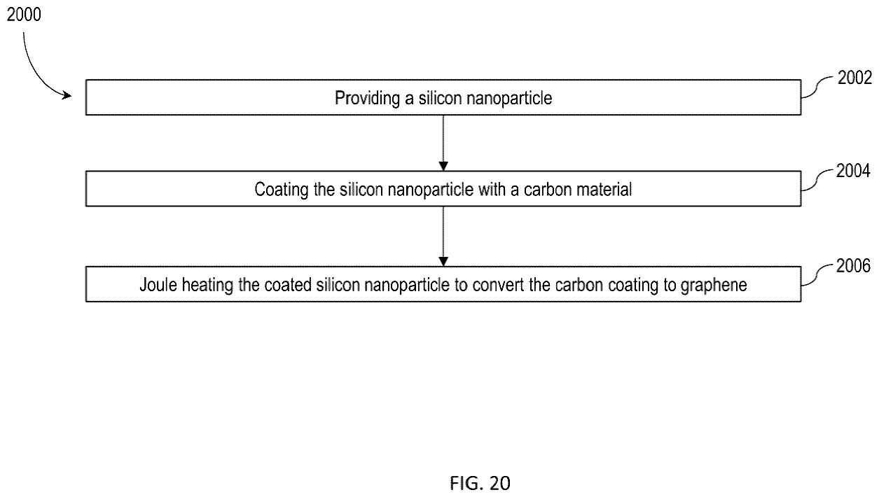

Referring now to FIG. 20, pictured therein is a flow chart describing a method 2000 of producing a silicon graphene composite material, according to an embodiment. Method 2000 includes steps 2002, 2004 and 2006. Method 2000 may be used to produce composite materials, for example, materials depicted in FIGS. 11, 12K, 12L, 13, and 14.
At 2002, a silicon nanoparticle is provided.
At 2004, the silicon nanoparticle is coated with a carbon material.
At 2006, the coated silicon nanoparticle is joule heated to convert the carbon coating to graphene.

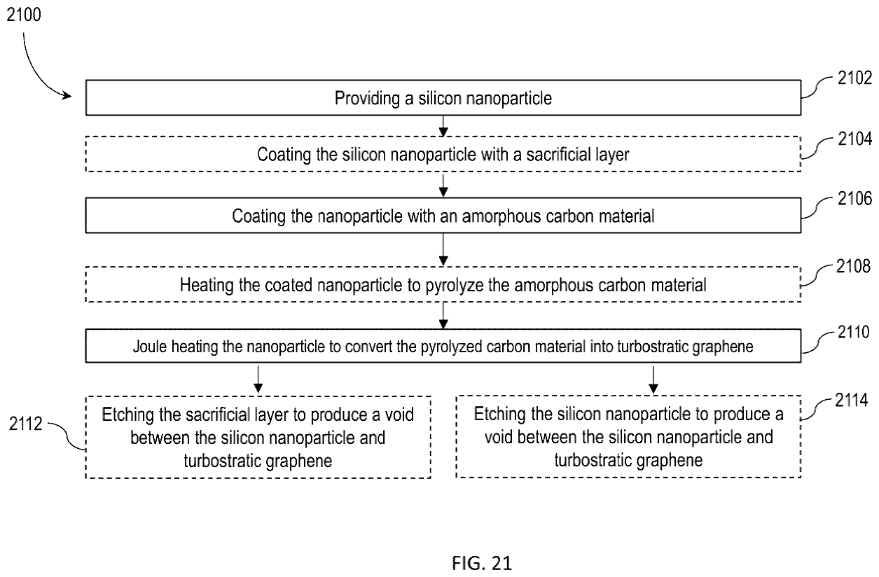

Referring now to FIG. 21, pictured therein is a flow chart describing a method 2000 of producing a silicon graphene composite material, according to an embodiment. Method 2100 includes steps 2102, 2106, and 2110. According to some embodiments, method 2100 may further include steps 2108, 2104 and 2112, and/or step 2114. Method 2100 may be used to produce composite materials, for example, the materials depicted in FIGS. 12A-12G.
At 2102, a silicon nanoparticle is provided.
At 2104, the silicon nanoparticle is coated with a sacrificial layer.
At 2106, the nanoparticle is coated with an amorphous carbon material.
At 2108, the coated nanoparticle is heated to pyrolyze the amorphous carbon material. The pyrolyzation process may increase the crystallinity and/or electrical conductivity of the amorphous carbon.
At 2110, the nanoparticle is joule heated to convert the carbon material from step 2106 or step 2108 into turbostratic graphene.
At 2112, the sacrificial layer is etched to produce a void between the silicon nanoparticle and turbostratic graphene.
At 2114, the silicon nanoparticle is etched to produce a void between the silicon nanoparticle and turbostratic graphene. In some examples, the silicon may be etched before conducting step 2110.

While the above description provides examples of one or more apparatus, methods, or systems, it will be appreciated that other apparatus, methods, or systems may be within the scope of the claims as interpreted by one of skill in the art.

1. A composite material, the material comprising:
a graphene nanoparticle, the graphene nanoparticle at least partially coated with silicon.

2. The material of claim 1, wherein the graphene nanoparticle is a turbostratic graphene nanoparticle, wherein the turbostratic graphene nanoparticle has graphene layers that are misoriented with respect to each other.

3. The material of claim 1 or 2, wherein the graphene nanoparticle is a polyhedral graphene nanoparticle.

4. The material of claim 1 or 2, wherein the graphene nanoparticle is a spherical graphene nanoparticle.

5. The material of any one of claims 1 to 4, wherein the graphene nanoparticle is porous.

6. The material of claim 5, wherein the pores of the graphene nanoparticle are at least partially filled with silicon.

7. The material of any one of claims 1 to 6, wherein the graphene nanoparticle comprises a hollow core.

8. The material of claim 7, wherein the hollow core is at least partially filled with silicon.

9. The material of any one of claims 1 to 8, wherein the silicon coating is coated with carbon.

10. The material of any one of claims 1 to 8, wherein the silicon coating is coated with graphene.

11. The material of claim 9, wherein the carbon coating is electrically conductive.

12. The material of any one of claims 1 to 11, wherein the silicon coating comprises a first layer of silicon, and a second later of silicon of differing compositions.

13. The material of claim 12, wherein the second layer is further coated with graphene.

14. The material of any one of claims 1 to 13, wherein the silicon coating comprises elemental silicon.

15. The material of any one of claims 1 to 14, wherein the silicon coating comprises SiO, SiOx, or SiO2.

16. The material of any one of claims 1 to 15, wherein the silicon coating comprises silicon carbide.

17. The material of any one of claims 1 to 16, wherein the material comprises a branched structure.

18. The material of any one of claims 1 to 17, wherein the graphene nanoparticle is doped with nitrogen.

19. The material of any one of claims 1 to 18, wherein the material is applied as a battery anode.

20. The material of claim 19, wherein the battery is a lithium ion battery.

21. The material of claim 19, wherein the battery is a sodium ion battery.

22. A composite material, the material comprising:
a silicon nanoparticle, the silicon nanoparticle at least partially coated with turbostratic graphene, wherein the turbostratic graphene has graphene layers that are misoriented with respect to each other.

23. The material of claim 22, wherein the graphene coating is porous.

24. The material of claim 22 or 23, wherein the graphene coating comprises polyhedral graphene.

25. The material of any one of claims 22 to 24, wherein the silicon nanoparticle comprises Si, SiO, SiOx, SiO2 or SiC.

26. The material of any one of claims 22 to 25, wherein the silicon nanoparticle comprises a first silicon layer and a second silicon layer of differing compositions.

27. The material of any one of claims 22 to 26, wherein the composite material comprises a void between the silicon nanoparticle and graphene coating.

28. The material of any one of claims 22 to 27, wherein the silicon nanoparticle comprises elemental silicon.

29. The material of any one of claims 22 to 28, wherein the silicon nanoparticle has a diameter between 5 nm and 50 microns.

30. The material of any one of claims 22 to 29, wherein the material is applied as a battery anode.

31. The material of claim 30, wherein the battery is a lithium ion battery.

32. The material of claim 30, wherein the battery is a sodium ion battery.

33. A material, the material comprising empty shell turbostratic graphene particles, wherein the turbostratic graphene nanoparticles have graphene layers that are misoriented with respect to each other.

34. The material of claim 33, wherein the graphene particles are porous.

35. The material of claim 33 or 34, wherein the graphene shell is filled with Li, Na, Sn, CO2, or H2.

36. The material of any one of claims 33 to 35, wherein the material is applied as a battery anode.

37. The material of claim 36, wherein the battery is a lithium ion battery.

38. The material of claim 36, wherein the battery is a sodium ion battery.

39. A method of producing a composite material, the method comprising:
providing a turbostratic graphene nanoparticle, wherein the turbostratic graphene nanoparticle has graphene layers that are misoriented with respect to each other; and
coating the graphene nanoparticle with a silicon material.

40. The method of claim 39, wherein the nanoparticle is coated by chemical vapor deposition.

41. The method of claim 39 or 40, wherein the graphene nanoparticle is a polyhedral graphene nanoparticle.

42. The method of claim 39 or 40, wherein the graphene nanoparticle is a spherical graphene nanoparticle.

43. The method of any one of claims 39 to 42, wherein the graphene nanoparticle is porous.

44. The method of claim 43, wherein the pores are filled with silicon.

45. The method of any one of claims 39 to 44, wherein the graphene nanoparticle comprises a hollow core.

46. The method of claim 45, wherein the hollow core is at least partially filled with silicon.

47. The method of any one of claims 39 to 46, further comprising coating the silicon coating with carbon.

48. The method of claim 47, wherein the carbon coating is electrically conductive.

49. The method of any one of claims 39 to 48, wherein the silicon coating comprises a first silicon layer and a second silicon layer of differing compositions.

50. The method of any one of claims 39 to 49, wherein the silicon coating comprises elemental silicon.

51. The method of any one of claims 39 to 50, wherein the silicon coating comprises SiO, SiOx, or SiO2.

52. The method of any one of claims 39 to 51, wherein the silicon coating comprises silicon carbide.

53. The method of any one of claims 39 to 52, further comprising forming the material into a branched structure.

54. The method of any one of claims 39 to 53, wherein the graphene nanoparticle is doped with nitrogen.

55. A method of producing a composite material, the method comprising:
providing a silicon nanoparticle;
coating the silicon nanoparticle with a carbon material; and
joule heating the coated silicon nanoparticle to convert the carbon coating to graphene.

56. The method of claim 55, wherein coating the silicon nanoparticle with a carbon material comprises direct carbon coating through thermal gas decomposition.

57. The method of claim 56, wherein the direct carbon coating comprises nitrogen doped carbon.

58. The method of claim 56, wherein the direct carbon coating comprises urea, melamine, glucosamine, cyanamide, amino acids, proteins, or chitin.

59. The method of claim 55, wherein coating the silicon nanoparticle with a carbon material comprises direct carbon coating through hydrothermal carbonization of carbohydrates.

60. The method of claim 59, wherein the carbohydrates comprise glucose, fructose, sucrose, or combinations thereof.

61. The method of claim 55, wherein the carbon material comprises carbon black.

62. The method of any one of claims 55 to 61, wherein the silicon nanoparticle comprises elemental silicon.

63. The method of claims 55 to 62, wherein the silicon nanoparticle comprises SiO, SiOx, or SiO2.

64. The method of any one of claims 55 to 63, wherein the silicon nanoparticle and carbon coating comprise a mass ratio between 90:10 and 10:90.

65. The method of any one of claims 55 to 64, wherein the graphene coating is porous.

66. The method of any one of claims 55 to 65, wherein the graphene comprises polyhedral graphene.

67. The method of any one of claims 55 to 66, wherein the composite material comprises a void between the silicon nanoparticle and graphene coating.

68. The method of any one of claims 55 to 67, wherein the silicon nanoparticle has a diameter between 5 nm and 50 microns.

69. A method of producing a composite material, the method comprising:
providing a silicon nanoparticle;
coating the nanoparticle with an amorphous carbon material;
heating the coated nanoparticle to pyrolyze the amorphous carbon material to increase the electrical conductivity of the amorphous carbon material; and
joule heating the nanoparticle to convert the pyrolyzed carbon material into turbostratic graphene, wherein the turbostratic graphene has graphene layers that are misoriented with respect to each other.

70. A method of claim 69, the method further comprising:
coating the silicon nanoparticle with a sacrificial layer before coating the nanoparticle with the amorphous carbon material; and
etching the sacrificial layer after the joule heating process to produce a void between the silicon nanoparticle and turbostratic graphene.

71. The method of claim 69, the method further comprising:
etching the silicon nanoparticle after the joule heating process to produce a void between the silicon nanoparticle and turbostratic graphene.

72. The method of claim 69, the method further comprising:
etching the silicon nanoparticle before the joule heating process to produce a void between the silicon nanoparticle and pyrolyzed carbon.
